(19) United States
(12) Patent Application Publication
(10) Pub. No.: US 2024/0176665 A1
(43) Pub. Date: May 30, 2024

(54) NOISY NEIGHBOR DETECTION

(71) Applicant: Intel Corporation, Santa Clara, CA (US)

(72) Inventor: Adrian Stanciu, Craiova (RO)

(73) Assignee: Intel Corporation, Santa Clara, CA (US)

(21) Appl. No.: 18/433,021

(22) Filed: Feb. 5, 2024

(51) Int. Cl. G06F 9/50

(52) U.S. Cl. CPC G06F 9/5027; G06F 2209/508

(57) ABSTRACT

A processor may aggregate cache misses in a cache, the cache shared by a plurality of input/output (I/O) sources. The processor may aggregate cache occupancy in the cache by the plurality of VO sources. The processor may and identify, based on the aggregating, a first I/O source of the plurality of I/O sources as impacting the cache.

### BACKGROUND

In computing environments, hardware resources may be shared by different system entities. As such, some entities may consume the hardware resources such that the performance of other system entities is negatively impacted.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a system in accordance with one embodiment.

FIG. 2 illustrates an aspect of the subject matter in accordance with one embodiment.

FIG. 3 illustrates an aspect of noisy neighbor detection in accordance with one embodiment.

FIG. 4 illustrates a flow diagram 400 in accordance with one embodiment.

FIG. 5 illustrates a flow diagram 500 in accordance with one embodiment.

FIG. 6 illustrates an aspect of noisy neighbor detection in accordance with one embodiment.

FIG. 7 illustrates a flow diagram 700 in accordance with one embodiment.

FIG. 8 illustrates an aspect of noisy neighbor detection in accordance with one embodiment.

FIG. 9 illustrates an aspect of noisy neighbor detection in accordance with one embodiment.

FIG. 10 illustrates a logic flow 1000 in accordance with one embodiment.

FIG. 11 illustrates an aspect a system 1100 in accordance with one embodiment.

### DETAILED DESCRIPTION

Embodiments disclosed herein provide techniques for noisy neighbor detection. Generally, a “noisy neighbor” may be a system entity (e.g., a hardware entity and/or a software entity) that impacts shared hardware resources such that another entity experiences performance issues, e.g., due to the lack of available shared hardware resources. The shared hardware resources may include any type of computing resource, such as processors, memories, caches, cache slices, peripheral devices (including Scalable I/O virtualization (SIOV) devices), queues, processor cores, accelerators, * Processing Unit (xPU), etc. The hardware entities may be any type of computing hardware, such as processors, memories, peripheral devices, SIOV devices, accelerator devices, Peripheral Component Interconnect Express (PCIe) devices, Compute Express Link® (CXL) devices, and the like. The software entities may be any type of software entities, such as tasks, workloads, applications, virtual machines, containers, processes, threads, and the like. The term “xPU” can refer to a Data Processing Unit (DPU), Infrastructure Processing Unit (IPU), Function Accelerator Controller (FAC), Network Attached Processing Unit (NAPU), or other processing units that offload and/or accelerate specialized tasks from a general purpose core.

In some embodiments, a plurality of buckets may be used at least in part to identify a noisy neighbor. A bucket may be associated with one or more identifiers, where the identifier is associated with a respective system entity. The identifiers may include a process identifier (PID) allocated to the software entity by an operating system (OS) and/or an address of an I/O source. The software entities may then execute on one or more computing systems. Metrics (e.g., telemetry data) associated with the execution of the software entities may be collected. The metrics may include, but are not limited to, memory use, cache use, use of peripheral devices, cache misses, input/output (I/O) use, bandwidth, instruction counts, head-of-line blocking events, congestion events, etc. In some embodiments, the metrics are aggregated for a bucket. In some embodiments, the system entities may be classified based on the metrics. The classification may classify one or more of the system entities as a noisy neighbor. In some embodiments, the classification may identify one or more of the buckets as including a noisy neighbor. Embodiments are not limited in these contexts.

In some embodiments, subsequent iterations may be used to further identify noisy neighbors. For example, in some embodiments, the metrics and/or classifications may be used to redistribute the system entities to the plurality of buckets. For example, if a first bucket includes a first software entity and a second software entity that have each been identified as noisy neighbors, the redistribution may cause the first and second software entities to be placed in separate buckets. For example, the first software entity may be redistributed to a second bucket of the plurality of buckets and the second software entity may remain in the first bucket (or assigned to a third bucket of the plurality of buckets). Service level objective (SLO) and/or service level agreement (SLA) factors may also be considered in the determination of mitigation actions. Additional metrics may then be collected as the redistributed software entities continue to execute. The metrics may be aggregated for each bucket. The system entities may be reclassified based on the metrics and one or more noisy neighbors may be identified. The process may continue for any number of iterations, as doing so may further refine results to pinpoint noisy neighbors. Redistribution is one possible mitigation action. Other mitigation actions could include: changing operating frequency of one or more devices, modifying one or more resource allocations, or terminating (or suspending) one or more tasks.

When a noisy neighbor (and/or a bursty neighbor) is identified, execution of the software and/or hardware entity may be adjusted. For example, a mitigation action may be applied to the execution of the software entity. The mitigation action may include any number and/or type of actions. For example, Quality of Service (QOS) enforcement may be implemented. In some embodiments, the QoS enforcement may be provided through priorities and/or capacity allocations (e.g., cache slicing). In some embodiments, software entities may be determined to have an affinity to a hardware entity (e.g., to a processor, a core, a processor socket, a die, etc.), and the software entities may be pinned to the hardware entity as a mitigation action. In some embodiments, the mitigation action includes configuring and/or disabling direct access to a cache by peripheral devices (e.g., Ethernet network interface controllers (NICs), etc.). In some embodiments, the mitigation action includes moving a software entity from one set of computing resources (e.g., a first server) to another set of computing resources (e.g., a second server). In some embodiments, the mitigation action includes SIOV isolation through Virtual Functions (VFs), which may include monitoring and/or enforcement of traffic generated by the VFs. In some embodiments, the mitigation action includes monitoring and/or enforcement of I/O traffic (e.g., traffic received via CXL links and/or PCIe Virtual Channels). In some embodiments, the mitigation action includes moving one or more tasks into or out of a secure enclave. In some embodiments, the mitigation action includes include change to packet pacing settings. In some embodiments, the mitigation action includes modifying the number of cache set-associative ways assigned to a core, virtual machine (VM), microservice, or task. Embodiments are not limited in these contexts.

Embodiments disclosed herein may more efficiently detect noisy neighbors in a computing environment. Some systems may execute tens of thousands (or more) of software entities and process traffic from many I/O sources. However, resource monitoring components of these systems may be limited to monitoring far fewer numbers of entities (e.g., tens or hundreds of entities, e.g., based on limited counts of resource monitoring identifiers). Therefore, these resource monitoring systems cannot track each of the tens of thousands (or more) system entities due to these constraints. However, by assigning these system entities to buckets, monitoring the resource use on a bucket level, and redistributing the system entities, these limitations may be overcome.

Reference is now made to the drawings, wherein like reference numerals are used to refer to like elements throughout. In the following description, for purposes of explanation, numerous specific details are set forth in order to provide a thorough understanding thereof. However, the novel embodiments can be practiced without these specific details. In other instances, well known structures and devices are shown in block diagram form in order to facilitate a description thereof. The intention is to cover all modifications, equivalents, and alternatives consistent with the claimed subject matter.

In the Figures and the accompanying description, the designations “a” and “b” and “c” (and similar designators) are intended to be variables representing any positive integer. Thus, for example, if an implementation sets a value for a=5, then a complete set of components 121 illustrated as components 121-1 through 121-a may include components 121-1, 121-2, 121-3, 121-4, and 121-5. The embodiments are not limited in this context.

Operations for the disclosed embodiments may be further described with reference to the following figures. Some of the figures may include a logic flow. Although such figures presented herein may include a particular logic flow, it can be appreciated that the logic flow merely provides an example of how the general functionality as described herein can be implemented. Further, a given logic flow does not necessarily have to be executed in the order presented unless otherwise indicated. Moreover, not all operations illustrated in a logic flow may be required in some embodiments. In addition, a logic flow may be implemented by a hardware element, a software element executed by a processor, or any combination thereof. The embodiments are not limited in this context.

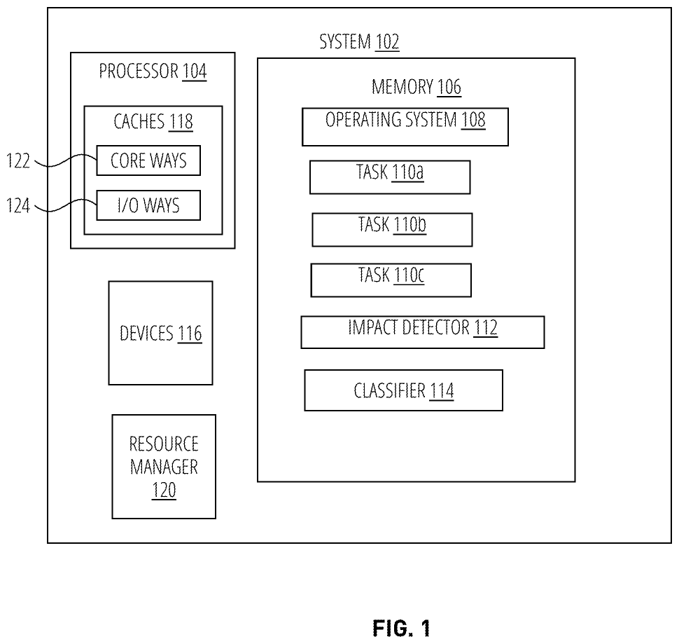

FIG. 1 illustrates an example system 102 for noisy neighbor detection, according to one embodiment. As shown, the system 102 comprises one or more processors 104 including one or more caches 118, a memory 106, one or more peripheral devices 116, and a resource manager 120. Although one instance of system 102 is depicted in FIG. 1, multiple instances of the system 102 may be used, e.g., to execute tasks on each instance of the system 102 (e.g., two or more processor sockets). In some embodiments, the components of the system 102 may be disaggregated across multiple systems (e.g., in a multi-root I/O virtualization (MR-IOV) environment). Embodiments are not limited in these contexts.

The system 102 is representative of any type of computing system. For example, the system 102 may be a server, a system-on-chip (SoC), a cloud computing node, a compute cluster, an Infrastructure Processing Unit (IPU), a data processing unit (DPU), a computer, a virtualized system, a gaming console, or any other type of computing system. The system 102 may be included in a datacenter cloud hosting and infrastructure environment, a communications environment, a content delivery network (CDN), a networking environment, industrial control environment, and the like.

As shown, the system 102 includes an operating system 108. The operating system 108 is representative of any type of operating system. In virtualized embodiments, a hypervisor, virtual machine manager (VMM), Kubernetes, and/or container manager may be executed in the system 102. The resource manager 120 provides a framework for controlling resource capacity allocations to different entities in the system 102 and monitoring the use of the resources. The resource manager 120 may be implemented in software, hardware, and/or a combination of hardware and software. Examples of a resource manager 120 include the Intel® Resource Director Technology (RDT) and the AMD® Platform QoS.

The device 116 is representative of any number and type of devices, such as a NIC, a storage device, an accelerator device, a graphics processing unit (GPU), etc. In some embodiments, the devices 116 are single root I/O virtualization (SR-IOV) devices. In some embodiments, the devices 116 are scalable I/O virtualization (SIOV) devices. Embodiments are not limited in these contexts.

The cache 118 is representative of any number and type of cache memories (e.g., an LI cache, an L2 cache, last level cache (LLC), etc.). In some embodiments, an LLC can be a n-way set associative last level cache (LLC) where n is any number greater than or equal to 2. In some embodiments, the cache is High Bandwidth Memory (HBM), or static random-access memory (static RAM or SRAM). As stated, some I/O devices 116 (e.g., NICs) may write data directly to the cache without first having to access main memory. Examples of such direct cache writing include the Intel Data Direct I/O Technology (DDIO). Therefore, as shown, the cache 118 may be allocated and/or partitioned into multiple cache ways, including core ways 122 (e.g., cache ways for use by the cores of processor 104) and the I/O ways 124 for I/O traffic (e.g., where the data is written directly to the cache 118 by the devices 116). Doing so may provide better system performance, lower power consumption, and/or lower latency. For example, a 12-way associative cache may be split into 8 core ways 122 and 4 I/O ways 124. However, when an I/O device writes data more frequently than the processor 104 can consume it (which may be referred to as oversubscription), data may be evicted from the cache 118 to memory 106. In this situation, the I/O device behaves like a noisy neighbor. The unnecessary cache evictions may reduce CPU performance and/or increase the power consumption by moving data back and forth between the cache 118 and memory 106. Embodiments are not limited in these contexts. For example, in some embodiments, the cache 118 is not allocated and/or partitioned into multiple ways.

The hardware of the computing system 102 (and/or another instance of the computing system 102) may be used to execute one or more tasks (which may be referred to as “workloads” herein). As shown, the memory 106 includes a task 110a, a task 110b, and a task 110c. However, any number of tasks may be executed, such as thousands of tasks (or more). The tasks 110a-110c are representative of any type of executable code. For example, the tasks 110a-110c may be a process, a thread, a virtual machine, a virtualized instance of hardware, a container, a microservice, an application, etc. Examples of workloads include database workloads, artificial intelligence (AI) workloads, storage workloads, inference workloads, mathematical workloads, virtual network function (VNF) applications, and the like. In some embodiments, each respective task is associated with a unique process identifier (PID). Embodiments are not limited in these contexts.

The tasks 110a-110b may share the hardware resources (e.g., the processor 104, memory 106, cache 118, devices 116, etc.) of the system 102. As such, some tasks may negatively impact the performance of other tasks. For example, the cache allocator may allocate more data in cache 118 for task 110a such that data of tasks 110b and/or 110c are evicted from the cache 118 and the tasks 110b-110c cannot benefit from having their data closer to the execution unit. Embodiments are not limited in these contexts. However, identifying such tasks is difficult in systems which execute tens of thousands of tasks (or more). Furthermore, system resource monitoring components such as the resource manager 120 may be limited to monitoring far fewer numbers of tasks (e.g., tens or hundreds of tasks).

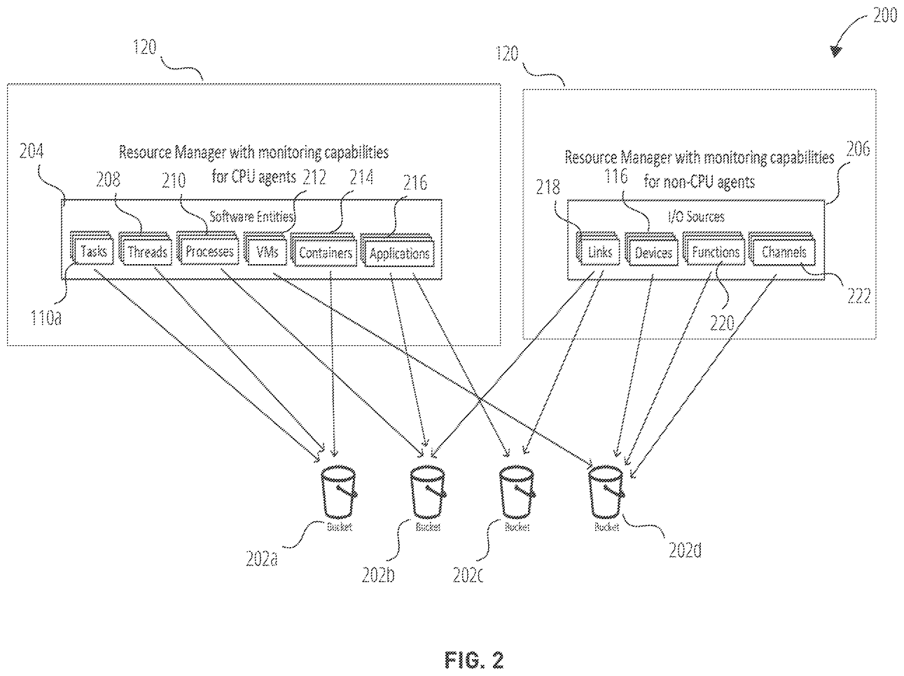

Other components of the system 102 may further use the resources of the system 102 (e.g., the memory 106 and/or caches 118). Such components may include the devices 116, communication links between system components, physical functions (PFs) of the devices 116, virtual functions (VFs) exposed by the devices 116, and/or communication channels (which may collectively be referred to as “I/O sources” herein, such as the I/O sources 206 of FIG. 2). As such, these I/O sources may negatively impact the performance of the system 102. I/O sources 206 may be identified by an address, which may be used by the resource manager 120 to tag communication traffic associated with the I/O sources 206.

Embodiments disclosed herein provide techniques to identify tasks and/or I/O sources that impact the use of shared resources by other tasks and/or I/O sources. As shown, the memory 106 includes an impact detector 112 and a classifier 114. The impact detector 112 and/or classifier 114 may be implemented in software, hardware, and/or a combination of hardware and software. For example, the impact detector 112 may be a part of the hypervisor level, the host OS level, and/or a container manager level. The impact detector 112 is generally configured to monitor the performance of tasks 110a-110c and/or I/O sources (such as the I/O sources 206 of FIG. 2) to identify active tasks and/or I/O sources such that the classifier 114 may identify one or more noisy neighbors, e.g., one or more tasks and/or I/O sources that impact the use of shared resources by at least one other task and/or I/O source. The shared resources may be any resource, such as the processor 104 (or any component thereof), the caches 118, the memory 106, the devices 116, a communications bus (e.g., as a Peripheral Component Interconnect Express (PCIe) interface, a Compute Express Link® (CXL) interface, a Universal Chiplet Interconnect Express (UCIe) interface, a die-to-die interface, the TSMC® system on integrated chip (SoIC) (TSMC-SOIC®), Open High Bandwidth Interface (OpenHBI), etc.), or any other type of hardware resource. In some embodiments, the impact detector 112 and/or the classifier 114 are system level components (e.g., components of the operating system 108 and/or components running on top of the OS). Embodiments are not limited in these contexts.

The classifier 114 is generally configured to classify tasks 110a-110c and/or I/O sources. The classifier 114 may be any type of classifier, such as a neural network, machine learning (ML) model, or rules-based classifier. In some embodiments, the classifier 114 may be trained based on training data (e.g., data describing a plurality of training tasks and/or I/O sources). In some embodiments, the training causes the classifier 114 to identify one or more tasks and/or I/O sources as noisy neighbors (or noisy neighbor candidates). In some embodiments, the classifier 114 may classify tasks 110a-110c and/or I/O sources based on performance metrics of each task 110a-110c and/or I/O source, where the performance metrics (also referred to as “telemetry data”) generally describe the use of shared resources by a given task and/or I/O source and/or the execution (and communication) performance thereof. Although the classifier 114 is depicted as being separate from the impact detector 112, in some embodiments, the classifier 114 is a component of the impact detector 112. Embodiments are not limited in these contexts.

When a noisy neighbor is identified, any number and type of remedial actions can be initiated by the impact detector 112. In some embodiments, QoS enforcement may be applied through cache slicing (also referred to as cache partitioning), priorities, and/or limits for different tasks 110a-110c and/or I/O sources 206. In addition and/or alternatively, tasks 110a-110c may be pinned to a component, such as a processor core, a socket, and/or a die. In addition and/or alternatively, the ability of peripheral devices to access hardware resources such as the cache may be configured and/or disabled. In addition and/or alternatively, tasks 110a-110c may be migrated to other systems. In addition and/or alternatively, SIOV isolation through virtual functions (VFs) may be applied, e.g., to monitor and/or enforce the traffic associated with VFs. In some embodiments, the impact detector 112 instructs the resource manager 120 to perform one or more of the remedial actions, such as QoS enforcement, cache slicing, pinning, etc. Embodiments are not limited in these contexts.

FIG. 2 is a schematic 200 illustrating techniques for neighbor detection, according to one embodiment. As stated, the resource manager 120 may cover entities executed by CPU-based agents (e.g., software entities 204 executing on one or more cores of the processor 104) and/or non-CPU agents (e.g., I/O sources 206). As shown, the software entities 204 include the tasks 110a-110c, threads 208, processes 210, virtual machines 212 (including any virtualized components of the system 102 such as virtual processors (“vCPUs”) exposed therein), containers 214, and applications 216 (which may be referred to collectively as “tasks” herein for case of explanation). The non-CPU agents are agents which may read from and/or write to memory 106 and/or caches 118. Examples of non-CPU agents include, but are not limited to, Peripheral Component Interconnect Express (PCIe) devices, Compute Express Link® (CXL) devices, accelerator devices, and the like. Therefore, as shown, the I/O sources 206 include links 218 (e.g., CXL links), the devices 116, functions 220 (e.g., physical functions and/or virtual functions), and/or channels 222 (e.g., PCIe virtual channels). An I/O source 206 may therefore be a device 116 and/or a part of the device 116 (e.g., one or more channels 222, one or more functions 220, and/or one or more links 218).

A resource monitoring ID (RMID) may be associated with one or more shared resource consumers being monitored. By associating RMIDs with buckets, buckets as a whole may become the monitored resource consumers. In some embodiments, the RMID is allocated by the operating system 108, the resource manager 120, and/or the impact detector 112. Therefore, the resource manager 120 may monitor shared resource utilization via the RMIDs. The impact detector 112 may flexibly associate RMIDs with software entities 204 that can be scheduled on the processor and/or I/O traffic of the I/O sources 206. In some embodiments, the I/O traffic is associated with Remote Direct Memory Access (RDMA) transfers or (nonvolatile memory express) NVMe operations.

In some embodiments, for the software entities 204, the resource manager 120 exposes a mechanism to specify the active RMID of a processor core (e.g., via one or more model specific registers (MSRs)). The MSRs may allow software such as the operating system 108 (and/or hypervisor, impact detector 112, VMM, or container manager) to specify an RMID when a software entity 204 is scheduled to run on a core. In some embodiments, for the I/O sources 206, the resource manager 120 may expose a mechanism to specify the RMID for upstream traffic and operation of the I/O sources 206.

As stated, the resource manager 120 may monitor the use of resources by the software entities 204 and/or I/O sources 206. For example, the resource manager 120 may include capabilities to monitor and control use of the caches 118 and/or the memory 106, allocate the caches 118 and/or memory 106 to tasks, monitor bandwidth (e.g., memory 106 bandwidth, bandwidth of the caches 118, bandwidth of the devices 116, etc.), allocate bandwidth capacity (e.g., of the memory 106 and/or caches 118), monitor occupancy of the caches 118, control capacity allocation of the caches 118, and/or code and data prioritization. Therefore, the resource manager 120 is configured to provide a variety of metrics (e.g., telemetry data) describing the use of hardware resources by consuming entities in the system 102. For example, by monitoring cache occupancies, the resource manager 120 may provide occupancy counters on a per-RMID basis, such that cache occupancy by each RMID may be tracked and read back in real-time during system operation. The resource manager 120 may also provide cache capacity allocation to allow control over shared cache space within a resource domain on a per-class of service (CLOS) basis. A resource domain may refer to a set of agents (e.g., one or more of the cores and/or I/O sources 206) sharing a set of resources.

By providing code and data prioritization, the resource manager 120 may provide differentiation between code and data for cache usage by a single CLOS. By providing memory bandwidth capacity allocation, the resource manager 120 allows software to control access bandwidth to memory 106 and/or the caches 118. By providing memory bandwidth monitoring, the resource manager 120 may monitor bandwidth from one level of cache 118 and/or resource hierarchy to the next (e.g., between L3 cache 118 and memory 106). By providing cache bandwidth capacity allocation, the resource manager 120 may provide control over processor cores and downstream memory bandwidth for each of the processor cores (e.g., bandwidth control between the caches 118 for each of the cores). Features of the resource manager 120 may be configured using model specific hardware registers and/or memory mapped input/output (MMIO) channels.

To facilitate the detection of noisy neighbors, the impact detector 112 may assign one or more software entities 204 and/or I/O sources 206 (and/or the respective RMIDs) to one of a plurality of buckets. As shown, example buckets include buckets 202a-202d. As explained in greater detail herein, the resource manager 120 and/or impact detector 112 may aggregate metrics for the software entities 204 and/or I/O sources 206 on a per-bucket level to detect noisy neighbors. The buckets 202a-202d are representative of any number of buckets, and may be implemented in any suitable data structure.

The RMIDs may be associated with any level of granularity. For example, a distinct software entity 204 and/or I/O source 206 may be individually tracked with a respective RMID. In some embodiments, software entities 204 may be grouped and tracked collectively (e.g., two or more threads of an application and/or VM, two or more applications executing in a VM, one or more virtual instances of processors 104 in a VM, one or more VMs, etc.). For example, adding one of the applications 216 to a bucket causes all of the threads associated with the application to that bucket such that the total resource use by the application may be monitored and aggregated using a single RMID. Similarly, adding one of the virtual machines 212 to a bucket allows the software entities of the VM (e.g., all guest operating system threads, all application threads, etc.) to be monitored and aggregated using a single RMID. In some embodiments, software entities 204 may be grouped while ignoring hierarchical relationships between them (e.g., distributing the threads of an application among different buckets, combining the threads from different applications in the same bucket, distributing the distinct links of a CXL device in different buckets, etc.). In some embodiments, when a bucket is determined to be associated with a noisy neighbor and/or the bucket is determined to be a noisy bucket, the impact detector 112 may cause the resource manager 120 to monitor individual tasks and/or I/O sources associated with the bucket.

The resource manager 120 may tag activity (e.g., requests, data, operations, traffic, etc.) to/from the memory 106 and/or caches 118 by the software entities 204 and/or I/O sources 206 with the associated RMIDs. The resource manager 120 may maintain and aggregate shared resource utilization for each RMID. If multiple resource consumers within a domain are assigned the same RMID, the resource manager 120 and/or impact detector 112 may aggregate and report the total shared resource utilization by these consumers. More generally, the impact detector 112 accesses the resource utilization data gathered by the resource manager 120. For example, the impact detector 112 may access resource utilization data via the counter registers of the resource manager 120.

In some embodiments, the resource manager 120 may control shared platform resources using CLOS tags. A CLOS tag may enable resource capacity allocation. More generally, a CLOS tag may correspond to a priority level. The resource manager 120 may associate (or otherwise configure) a CLOS with a software entity 204 and/or I/O sources 206. In some embodiments, CLOS may be associated with multiple resource allocation constraints (e.g., L2 & L3 capacity available, memory bandwidth available, etc.). A resource constraint may describe the resource capacity and the degree of overlap/isolation between classes (e.g., using bitmasks). Constraints may be described as fractions/percentages of the shared platform resources. Constraints may be bandwidth throttle levels. Embodiments are not limited in these contexts.

More generally, the resource manager 120 may associate one or more devices 116 such as a PCIe device or a CXL device to an RMID and/or a CLOS. Similarly, the resource manager 120 may associate one or more PCIe virtual channels 222 to an RMID and/or a CLOS. Similarly, the resource manager 120 may associate one or more CXL links 218 to an RMID and/or a CLOS. Similarly, the resource manager 120 may associate one or more PCIe physical functions 220 to an RMID and/or a CLOS. Similarly, the resource manager 120 may associate one or more PCIe virtual functions 220 to an RMID and/or a CLOS.

In some embodiments, for software entities 204, the resource manager 120 may expose a mechanism to specify the active CLOS of the software entity 204 executing on a core of a processor 104. The mechanism may be exposed via one or more MSRs. The MSR allows the operating system 108 (and/or a hypervisor, VMM, or container manager) to specify a CLOS when a software entity 204 is scheduled to execute on a core. For I/O sources 206, the resource manager 120 may expose a mechanism to specify the CLOS for upstream traffic and operation of the I/O sources 206. The resource manager 120 may then perform resource capacity allocation control for the software entities 204 and I/O sources 206 based on the CLOS and associated resource constraints.

The maximum number of RMID/CLOS tags for each resource level and resource domain may be limited, e.g., may be model/product specific. This maximum number may determine how many unique IDs the software impact detector 112 may use. As stated, the resource manager 120 may monitor and store per-RMID resource utilization metrics over time (e.g., using cache line tags and/or per-RMID counters). In some embodiments, the stored metric data may be reset, as the resource manager 120 may offer a mechanism to reset the data. After reset, the reported per-RMID resource utilization metric data is zero (or close to zero).

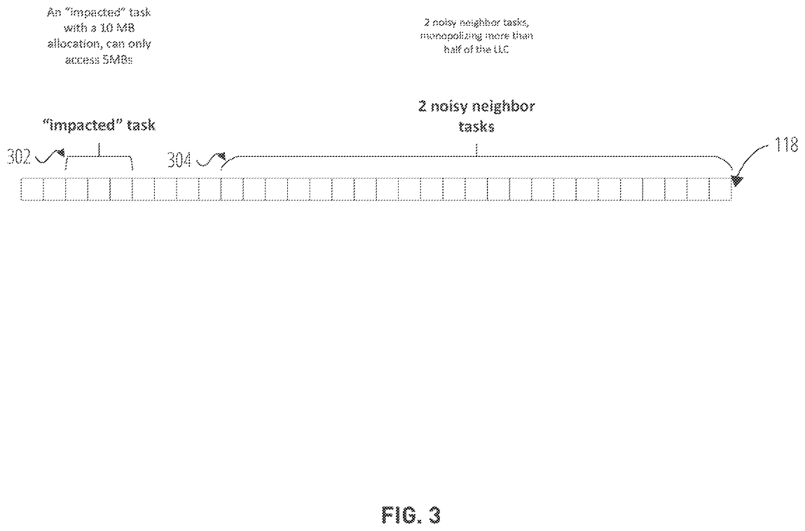

FIG. 3 is a schematic 300 illustrating an example of noisy neighbor detection, according to one embodiment. Generally, the cache 118 may be allocated into several portions for use by the tasks 110a-110c. For example, the cache allocator may allocate the full working set of task 110a (e.g., ten megabytes) from memory 106 to the cache 118 to task 110a. However, as shown, cache portion 302 may reflect the actual amount of cache 118 (e.g., 5 megabytes) available to task 110a, while cache portion 304 may reflect the amount of cache 118 used by tasks 110b and 110c.

In the example depicted in FIG. 3, the cache portion 302 may be limited to less than the full working set (e.g., five megabytes) of task 110a, meaning task 110a is not able to benefit from having its full working set brought closer to the execution unit (e.g., the processor 104). This may be due at least in part on the cache portion 304 used by tasks 110b, 110c, which are allocated more than half of the cache 118 (e.g., because a noisy neighbor task may cause the cache allocator to allocate additional portions of the cache with continuous memory access patterns). Therefore, tasks 110b and/or 110c may be noisy neighbors, as the use of the cache 118 by these tasks impacts the ability of task 110a to access the full working set in the cache 118, which may degrade performance of the task 110a in execution. Stated differently, the noisy tasks may impact the cache based on the amount of cache used by the noisy tasks limiting other tasks and/or I/O sources from accessing their full cache allocations. The noisy neighbors may occur for any number of reasons, such as tasks that experience sudden bursts of high resource use, misconfigured and/or insufficient task isolation such that the resource use of one task can leak into other instances, resource intensive tasks, and/or overprovisioning (e.g., where a system hosts more tasks than the system can handle efficiently). In the context of a cache such as cache 118, a noisy neighbor may occur due to the limited size of the cache, the eviction of useful data, cache pollution (e.g., unnecessary fetches to the cache and/or evictions from the cache), task execution on processor cores that share the same slice of the cache, and/or I/O devices such as devices 116 making direct writes in the cache. Embodiments are not limited in these contexts.

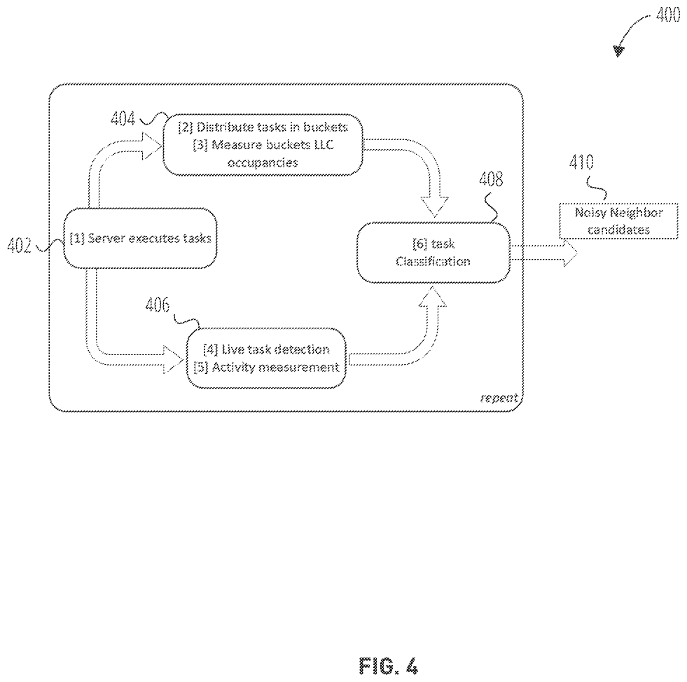

FIG. 4 illustrates a flow diagram 400 for noisy neighbor detection, according to one embodiment. Although the flow diagram 400 is discussed with reference to software entities 204 (e.g., tasks 110a-110c), the flow diagram 400 may be applied to the I/O sources 206. Embodiments are not limited in these contexts.

As shown, at block 402, one or more tasks such as tasks 110a-110c may execute on a system such as system 102. The impact detector 112 may query the OS (and/or Hypervisor, Guest OS, and/or container manager) for a list of tasks and/or I/O sources 206 in the system. At block 404, the impact detector 112 may associate each task (e.g., a PID) with respective buckets of a plurality of buckets (e.g., buckets 202a-202d) in a data structure and/or memory element. For I/O sources 206, the impact detector 112 may associate the address of the I/O source 206 with a bucket (as I/O sources 206 may not have associated PIDs). Generally, doing so causes the impact detector 112 to “distribute” the tasks to different buckets 202a-202d, such that each task is assigned to a bucket 202a-202d. For example, task 110a may be associated with bucket 202a while tasks 110b and 110c may be associated with bucket 202b. Furthermore, each bucket may be associated with one of the RMIDs. Embodiments are not limited in these contexts.

The impact detector 112 may further monitor performance metrics associated with the execution of each task at block 404. For example, the impact detector 112 may receive metrics from the processor 104, the operating system 108, the resource manager 120, applications 216 (e.g., number of concurrent clients of a web server application, a total number of client connections, etc.) and/or any other component of the system 102 (e.g., a performance monitoring unit, etc.). The performance metrics may include any number and type of metrics describing the use of resources of the system 102 by a given task 110a-110c. Example metrics include, but are not limited to, cache misses, cache occupancies, instruction counters, bandwidth (e.g., bandwidth between any two components of the system 102), resource use based on time, processor cycles, task scheduling information, resource occupancy, communication channel use, etc. Embodiments are not limited in these contexts. In some embodiments, at block 404, the impact detector 112 may aggregate the metrics on a bucket level (e.g., metrics for bucket 202a, etc.) and determine the resource use for each bucket based on the aggregated metrics. For example, if tasks 110b and 110c are associated with bucket 202b, the impact detector 112 aggregates the metrics for at least tasks 110b and 110c to determine the resource use by bucket 202b (which may include other tasks associated with bucket 202b). In some embodiments, however, the metrics monitored and/or collected at block 404 may be at the bucket level, thereby monitoring at the bucket level without aggregating.

At least a portion of block 406 may occur in parallel with block 404. In some embodiments, the observed cache misses may correspond to evolutions of the occupancies in each cache 118. In block 406, the impact detector 112 may identify active tasks (e.g., one or more of the tasks 110a-110c that are actively executing on system resources). For example, the impact detector 112 may receive, from one or more of the operating system 108, processor 104, resource manager 120 (and/or another system component such as a performance monitoring unit (PMU)), metrics for each of the tasks 110a-110c. As stated, the metrics can be any type of metrics, such as cache misses, cache occupancies, instruction counters, bandwidth (e.g., bandwidth between any two components of the system 102), resource use based on time, processor cycles, task scheduling information, resource occupancy, communication channel use, etc. The metrics may be at a task level and/or a bucket level. The impact detector 112 may then evaluate the activity of each task 110a-110c based on the metrics. Doing so may allow the impact detector 112 to return, for each task 110a-110c, an indication of whether the task 110a-110c is an active task or an inactive task.

In some embodiments, the impact detector 112 may use random sampling to identify active tasks. Doing so may not identify some or all active tasks. For example, in some embodiments, the execution of a task on a processor core may be interrupted at randomized and/or predetermined time intervals (e.g., 50 milliseconds, etc.). The impact detector 112 may identify the interrupted task as an active task because it was interrupted during execution. Other intervals may be used to interrupt the processor, such as a predetermined number of instructions, a predetermined number of processor cycles, a predetermined number of cache misses, or any predetermined performance monitoring event. Such sampling may identify active tasks using fewer resources than actively tracking all executing tasks.

At block 408, the impact detector 112 may cause the classifier 114 to classify each task 110a-110c. The classifier 114 may classify each task based on the metrics collected at blocks 404 and 406. Doing so may cause one or more tasks 110a-110c to be returned at block 410 as noisy neighbor candidates. In some embodiments, the classifier 114 may classify one or more of the tasks 110a-110c as noisy neighbors after metrics are collected for the current iteration and/or in parallel with measurements in a subsequent iteration. In some embodiments, the impact detector 112 and/or classifier 114 may cause a mitigation action (also referred to as a corrective action) to be performed based on the identification of the noisy neighbor task. Embodiments are not limited in these contexts.

In some embodiments, additional iterations of the flow diagram 400 may be performed, such that noisy neighbor tasks are pinpointed through redistribution of the tasks into buckets 202a-202d and metric collection. Generally, buckets that contain a noisy neighbor may behave like a noisy neighbor. Therefore, a bucket may track the cache occupancies of the constituent tasks during a given iteration. As such, the cache occupancy of a bucket may be greater than the cache occupancy by a given one of the constituent tasks. More generally, if a bucket is identified as a noisy neighbor candidate, then the classifier 114 may consider all tasks in the same bucket (and/or all active tasks in the same bucket) as noisy neighbor candidates. As stated, in some embodiments, all tasks and/or I/O sources associated with a bucket that has been classified as a noisy neighbor (and/or a noisy neighbor candidate) may be individually monitored by the resource manager 120.

For example, if tasks 110b and 110c are associated with bucket 202b in the first iteration, the tasks 110b, 110c may be redistributed into different buckets in subsequent iterations. In such an example, the task 110b may be associated with bucket 202c and the task 110c may be associated with bucket 202d. By associating the tasks with different buckets, the impact of the actual noisy neighbor may be detected. For example, if task 110c is a noisy neighbor candidate and task 110b is not a noisy neighbor candidate, the inclusion of tasks 110b and 110c in the bucket 202b may not isolate task 110c from task 110b due at least in part to the metrics collected for task 110b, task 110c (and/or other tasks) as belonging to the same bucket. However, by associating task 110c with bucket 202d in subsequent iterations, task 110c may be identified as a noisy neighbor. Similarly, the association of non-noisy task 110b with the bucket 202c may cause the task 110b to be filtered from consideration as a noisy neighbor for the current iteration (e.g., based on the aggregated metrics associated with task 110b and/or the bucket 202c indicating a noisy neighbor is not present in the bucket 202c). In embodiments where both tasks 110b and 110c are noisy neighbor candidates in the same bucket, the redistribution of tasks 110b, 110c into different buckets may cause these different buckets to act as noisy neighbors in subsequent iterations. In some embodiments, the additional iterations of the flow diagram 400 may end once a predetermined threshold number of iterations has been completed. Embodiments are not limited in these contexts.

As stated, block 404 may include the impact detector 112 redistributing the tasks to the buckets, e.g., in subsequent iterations of the flow diagram 400. The redistribution may be based on any algorithm. In some embodiments, the algorithm may include filtering tasks based on the metrics and/or classifications. Generally, the algorithm may attempt to reduce collisions between noisy neighbor candidates, e.g., to reduce placing two or more noisy neighbor candidate tasks in the same bucket. Collisions may not provide additional information to the impact detector 112 and/or classifier 114 and may indirectly slow down the identification of noisy neighbors. As the number of available RMIDs can be several orders of magnitude smaller than the number of tasks in the system 102, avoiding bucket collisions is difficult. In some embodiments, the impact detector 112 redistributes the tasks to buckets based on one or more of: (i) reducing collisions between tasks that have been executed, (ii) reducing collisions between tasks that have high resource use (e.g., high numbers of cache misses), (iii) reducing collisions of tasks that were previously associated with noisy buckets, or (iv) reducing collisions between tasks that have been placed in the same bucket in previous iterations.

In some embodiments, the redistribution algorithm includes the impact detector 112 assigning active tasks (e.g., tasks that have been executed, scheduled tasks that have predetermined execution footprints, etc.) while reducing the bucket collision count. The cardinality of the active task subset is smaller than the system-wide task count. This makes the bucket assignment more tractable than a random redistribution algorithm and allows the total collision count to be reduced. Furthermore, the redistribution algorithm may include the impact detector 112 filling the buckets with tasks according to a randomization function and/or equally with the rest of the tasks. This handles the dynamic nature of a live system executing thousands of tasks and prepares for new or “hibernating” tasks that may reveal themselves as noisy neighbors in the current iteration. For example, the algorithm may include the impact detector 112 filling buckets with inactive tasks. Embodiments are not limited in these contexts.

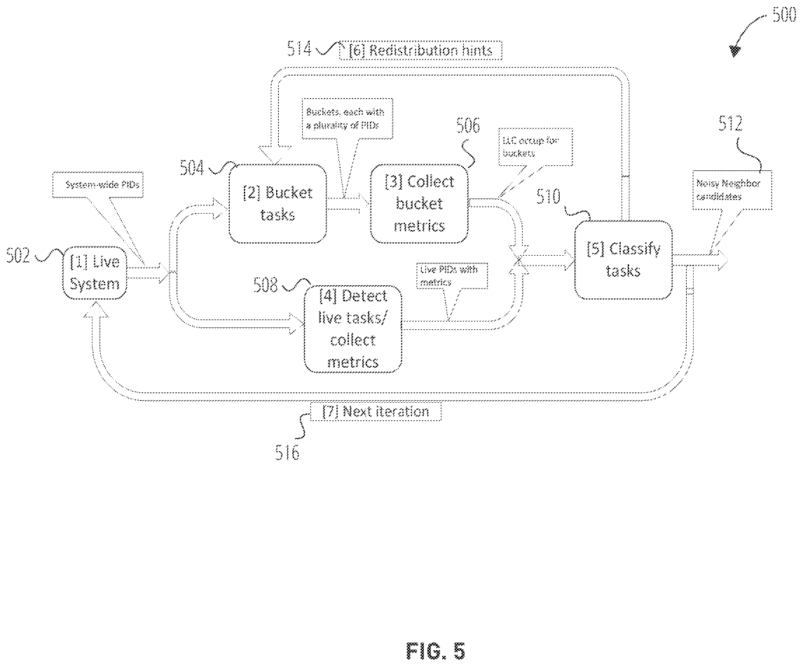

FIG. 5 illustrates a flow diagram 500 for noisy neighbor detection, according to one embodiment. Although the flow diagram 500 is discussed with reference to software entities 204 (e.g., tasks 110a-110c), the flow diagram 500 may be applied to the I/O sources 206. Embodiments are not limited in these contexts.

At block 502, a plurality of tasks may be executed on one or more computing systems such as system 102. Respective tasks of the plurality of tasks may be associated with a respective PID. The impact detector 112 may query the OS (and/or Hypervisor, Guest OS, Container Manager, etc.) for a list of tasks and/or I/O sources 206 in the system. At block 504, the impact detector 112 may distribute the plurality of tasks to a plurality of buckets (e.g., buckets 202a-202d). Generally, the distribution associates at least one of the tasks (e.g., via the PID) to a respective bucket, such that each bucket 202a-202d is associated with one or more tasks. As stated, for the I/O sources 206, the impact detector 112 may associate the address of the I/O source 206 with a bucket. However, because the number of tasks may greatly exceed the number of available RMIDs, each bucket may be associated with multiple tasks. Furthermore, at block 504, each bucket may be associated with one of the RMIDs. However, as stated, the resource manager 120 is limited to a predetermined number of RMIDs. These hardware limitations may constrain the measurements that can be performed in parallel (e.g., measuring cache occupancy, cache misses, etc.). By distributing the tasks 110a-110c to buckets, and associating each bucket with an RMID, the metrics of all buckets (and associated resource consumers) may be measured in parallel.

At block 506, the impact detector 112 may collect or otherwise access metrics reflecting the use of a shared resource by the plurality of tasks. As stated, the metrics can be any type of metrics, such as cache misses, cache occupancies, instruction counters, bandwidth (e.g., bandwidth between any two components of the system 102), resource use based on time, processor cycles, task scheduling information, resource occupancy, communication channel use, etc. As stated, the impact detector 112 may receive the metrics from one or more of the processor 104, the operating system 108, the resource manager 120, the PMU, or other component of the system 102. In some embodiments, the impact detector 112 and/or the resource manager 120 may aggregate the metrics on a bucket level, thereby aggregating the metrics for each task associated with a respective bucket.

For example, in some embodiments, the impact detector 112 may create one or more buckets 202a-202c (e.g., for cache occupancies, for cache misses, and/or for cache hits, etc.) and associate each bucket with one or more tasks 110a-110c (and/or one or more I/O sources 206). Doing so allows tasks to be scheduled, the RMIDs to be maintained, and the metrics associated with a given task to be aggregated on a bucket level.

Block 508 may be performed in parallel with blocks 504 and/or 506. Generally, at block 508, active tasks may be identified by the impact detector 112. Generally, an active task may be a task which is actively executing or otherwise using system resources. There fore, if the impact detector 112 determines that a task is (or was) inactive, the inactive task may be filtered out or otherwise discarded from further consideration as a noisy neighbor (e.g., because an inactive task is unlikely to be a noisy neighbor). To identify active and/or inactive tasks, the impact detector 112 may request, from the operating system 108 and/or PMU, actively scheduled tasks (e.g., based on PID) and corresponding metrics (e.g., cycles, instructions, cache misses, cache occupancies, etc.). The impact detector 112 may then identify active and/or inactive tasks based on the response from the operating system 108. For example, if the data returned by the operating system 108 indicates a first task was not scheduled for execution, the impact detector 112 may determine the first task is inactive. Similarly, if the data returned from the operating system 108 indicates a second task was scheduled to execute on the processor 104, the impact detector 112 may determine the second task is active. Often, tasks with a high execution footprint (e.g., based on high numbers of clock cycles, instructions, cache misses, or cache occupancies, execution times, etc.) may be more likely to be a noisy neighbor. Therefore, in some embodiments, the impact detector 112 may apply one or more thresholds to filter out active tasks having metric use that does not exceed the thresholds. For example, if the second task has a cache miss count that does not exceed a cache miss threshold, the impact detector 112 may filter the second task from further noisy neighbor consideration. As another example, the rate of cache misses over the duration of an execution slice may be used as a threshold.

In some embodiments, the impact detector 112 may filter I/O sources 206 based on collected metrics. For example, the impact detector 112 may filter the I/O sources 206 based on the number messages transmitted to and/or received from an I/O source 206, the utilization of transmit queues and/or receive queues of the I/O sources 206, and one or more thresholds. In some embodiments, the impact detector 112 may identify the I/O sources 206 as being active if the counters or other metrics exceed a threshold.

In some embodiments, blocks 506 and 508 may execute until a predetermined stop condition for the current iteration. The stop condition may be one or more of a predetermined time threshold, one or more buckets having metric use that exceeds a bucket use threshold (which may be based on the maximum allocated capacities for the bucket), a metric for a resource exceeding a resource use threshold, and/or the metrics of one or more tasks exceeding a task threshold. In some embodiments, the classifier 114 may use the buckets having metric use that exceeds a bucket use threshold to classify the bucket as noisy buckets.

At block 510, the classifier 114 may classify each task based on the metrics collected at blocks 506 and 508. The classifier 114 may store a history of the metrics collected at blocks 506 and 508 (e.g., based on previous iterations of the flow in flow diagram 500). The classifier 114 may receive the new metrics collected at blocks 506 and 508, and classify the tasks into one or more categories. The categories may be predetermined and/or learned during the training of the classifier 114. Example categories include noisy neighbors, non-noisy neighbors, and bursty tasks. For example, the classifier 114 may classify tasks as noisy neighbors when the tasks have metrics which indicate high levels of resource use (e.g., where the resource use is above a threshold and/or is close to the maximum allocated capacity for the bucket). Generally, tasks in noisy buckets with high metrics (e.g., high cache misses, high cache occupancies, etc.) are more likely to be noisy neighbors. Similarly, individually monitored tasks (e.g., where a bucket is associated with a single task) that have metrics indicating resource use that approaches the total allocated capacity by the resource manager 120 may have higher chances of being a noisy neighbor. For example, if the individually monitored task is constrained to 10 megabytes of cache and is allocated 9.9 megabytes of cache, the task may be classified as a noisy neighbor by the classifier 114. As another example, a task with metrics that indicate noisy-neighbor like behavior (e.g., spikes in resource utilization) during isolated iterations (but not across a threshold number of other iterations) may be classified as a bursty task by the classifier 114. As another example, a task with metrics that indicate consistent noisy-neighbor like behavior (e.g., spikes in resource utilization) only during N consecutive iterations, where N is small (e.g., 1-10 iterations) may be classified as a bursty task by the classifier 114.

Therefore, at block 512, the output of the classifier 114 may include one or more noisy neighbor candidates. As stated, in some embodiments, all tasks and/or I/O sources associated with a bucket that has been classified as a noisy neighbor (and/or a noisy neighbor candidate) may be individually monitored by the resource manager 120. The output of the classifier 114 may be used as redistribution hints in block 514 for the next iteration of the flow diagram 500, e.g., to redistribute the tasks in another iteration of block 504. In some embodiments, the output of the classifier 114 may include the metrics and categories for each resource consumer (e.g., tasks 110a-110c and/or I/O sources 206). For example, the classifier 114 may indicate a task 110a was active during one or more previous iterations. At block 516, the flow diagram 500 may return to block 502 for one or more iterations. In some embodiments, if the classifier 114 classifies a task as a noisy neighbor, a mitigation action may be performed without requiring additional iterations of the flow diagram 500. In some embodiments, however, additional iterations of the flow diagram 500 may be performed to reclassify the task as a noisy or non-noisy neighbor based on resource use at each iteration.

As stated, impact detector 112 may redistribute the tasks to buckets in block 504. The following is an example of redistributing buckets. In the example, the tasks 110a-110c may include 50,000 tasks, while only 10 of the tasks are noisy neighbors. In the example, 50 buckets may be provided, e.g., based on using 50 RMID tags. In a first iteration, the impact detector 112 may distribute the tasks equally to the 50 buckets, e.g., by assigning 1,000 tasks to each bucket. After the first iteration, a first bucket may have the largest cache occupancies of all the buckets (e.g., 90%), so the first bucket may contain all of the noisy neighbors. The impact detector 112 may determine that 10% of the tasks from each bucket may have been active during the first iteration. Therefore, after the first iteration, 100 active tasks have been in a noisy bucket one time, 4,900 tasks have been in noisy buckets zero times, and 900 inactive tasks have been in a noisy bucket one time. Doing so may reduce the set of noisy neighbor candidates (the active tasks in noisy buckets in the past iteration) from 50,000 to 100.

The impact detector 112 may then perform a second redistribution. However, if the impact detector 112 places the reduced set of candidates (e.g., the 100 active tasks in the first noisy bucket) into the same bucket in the second iteration, then at the end of the second iteration, the impact detector 112 may not gain any new information about these candidates. Instead, the impact detector 112 may redistribute the 100 noisy neighbor candidate tasks from the first bucket into the 50 buckets (for a total of 2 tasks in each bucket). Once the active tasks from the first bucket have been assigned to the 50 buckets, the impact detector 112 may add the rest of tasks equally among the 50 buckets.

In some embodiments, the impact detector 112 considers collisions over the previous M iterations, (e.g., 1 iteration, 2 iterations, etc.) to try to separate noisy neighbor tasks into different buckets (e.g., to isolate candidates). For example, in some embodiments, the classifier 114 receives bucket occupancies and task activity from the impact detector 112 at each iteration. The classifier 114 may use a windowing mechanism (past N iterations) to further classify tasks as: (i) tasks that have been active A1 times in the past A2 iterations, or (ii) tasks that have been in noisy buckets for N1 times in the past N2 iterations. The classifier 114 may output noisy neighbor candidates as tasks that have been active A1 times in the past A2 iterations and have been in noisy buckets for N1 times in the past N2 iterations. Then, in the next iteration, the impact detector 112 may first distribute the tasks which have been active A1 times in the past A2 iterations such that collisions in the past C iterations are reduced/minimized.

Therefore, the impact detector 112 uses an algorithm that considers one or more of: (i) reducing collisions between tasks that have been executed, (ii) reducing collisions between tasks that have high resource usage (e.g., high numbers of cache misses), (iii) reducing collisions of tasks that were previously associated with noisy buckets, or (iv) reducing collisions between tasks that have been placed in the same bucket in previous iterations. Embodiments are not limited in these contexts.

As stated, in some embodiments, a noisy neighbor task and/or I/O source (and/or candidate noisy neighbor tasks or I/O sources) may be monitored individually. For example, when the current list of noisy neighbor task candidates is small enough (e.g., tens of tasks), the impact detector 112 may determine to individually monitor these tasks by filling buckets with one task. Therefore, in such an example, each bucket, which is associated with one task, corresponds to one task per RMID. Stated differently, tasks that are individually monitored (e.g., by being the only task assigned to a bucket) exclusively reserve an RMID.

In some embodiments, the impact detector 112 implements individual monitoring by continuously pinning the bucket (with a single task) to a fixed RMID over multiple iterations. Individually monitored tasks are not impacted by RMID reuse and, over time, the metrics for the individually monitored task (e.g., memory bandwidth, cache occupancy, etc.) will approach actual values. Therefore, the accuracy and/or quality of the metrics of these tasks increases over time, which provides better inputs to the classifier 114. Furthermore, the cache occupancies of buckets with individual tasks correspond to cache occupancies of the individual tasks themselves. When cache capacity allocation is used, a task with cache utilization (which may be referred to as “cache occupancies”) close to the allocated capacity has a higher chance of being a noisy neighbor. Therefore, in some embodiments, the impact detector 112 may query the cache occupancies of tasks as needed. In some embodiments, the impact detector 112 stops directly monitoring an individually monitored task when the task is no longer a classified as a noisy neighbor and/or noisy neighbor candidate.

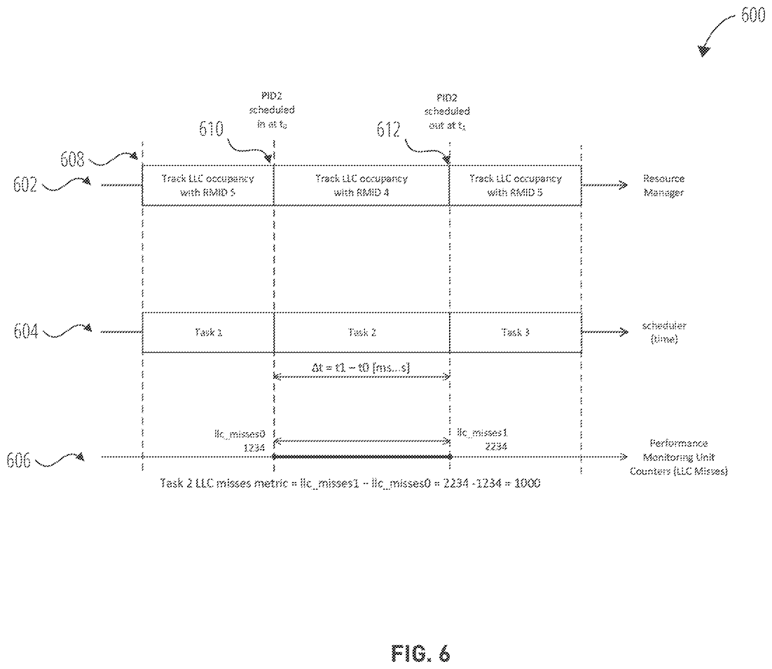

FIG. 6 is a schematic 600 illustrating an example of detecting active and/or inactive tasks, according to one embodiment. As stated, the impact detector 112 may access metrics describing the execution of the tasks 110a-110c on the processors 104 of system 102. The schematic 600 illustrates example metrics that may be provided by the operating system 108, a PMU, and/or resource manager 120. For example, the resource manager timeline 602 reflects the software entities being tracked by the resource manager 120, while a scheduler timeline 604 reflects software entities executed on one or more cores of one or more processors 104. Generally, a multitasking system such as system 102 may execute more than one task using a single shared core of processor 104. The scheduler timeline 604 reflects that an example task (“task 1”) may execute until a time 610 on the scheduler timeline 604, at which point an example task (“task 2”, associated with PID2 in FIG. 6) executes until time 612 on the scheduler timeline 604, at which point another task executes, and so on.

Each time a different task is to be executed, the operating system 108 may interrupt the executing task, save the state of the interrupted task, load the saved state of a different task to be executed, and transfer the control to the different task to be executed. Generally, tasks may be executed in slices of any granularity (e.g., milliseconds, microseconds, seconds, etc.). Furthermore, slices may have different durations. Doing so allows the detection of executed tasks (e.g., tasks that are active and may consume shared resources), allows the determination of a duration of the execution, and receive metrics (e.g., cache misses, cache occupancies, queue lengths, etc.) from the OS, resource manager 120, and/or PMU. Therefore, the impact detector 112 may determine when tasks start/stop being executed from the scheduler component of the operating system 108 and programs resource manager 120 with synchronicity.

The impact detector 112 may associate task 1 and an example task 3 with an example RMID 5. For example, the impact detector 112 may assign RMID 5 to a bucket 202a. Similarly, the impact detector 112 may associate task 2 with RMID 4, e.g., by assigning RMID 4 to bucket 202b. When the task 1 is scheduled on the processor (e.g., at time 608), the impact detector 112 may identify the bucket of task 1 and its RMID 5, and programs the resource manager to track the resource utilization with that RMID 5. When task 2 is scheduled on the processor (e.g., at time 610), the impact detector 112 may identify the bucket associated with task 2 and its RMID 4, and programs the resource manager 120 to track the resource utilization with RMID 4. When task 3 is scheduled (e.g., at time 612), the impact detector 112 may identify the bucket of the task 3 and its RMID 5, and program the resource manager 120 to track the resource utilization with RMID 5. When the impact detector 112 decides to stop monitoring, the impact detector 112 may program the resource manager 120 to stop tracking resource utilization.

When task 3 ends execution, the impact detector 112 may read the metrics collected by the resource manager 120 (e.g., LLC occupancies) which will provide the aggregated LLC occupancy of the tasks 1 and 3 (e.g., via the monitoring of RMID 5) and the individual LLC occupancy of task 2 (e.g., via monitoring RMID 4).

Furthermore, as shown, the metric counter 606 is a timeline showing the values of an example metric as the tasks execute according to the scheduler timeline 604. In the example depicted in FIG. 6, the metric is a count of cache misses (e.g., from the PMU). For example, at time 610, which may correspond to the time the task 2 associated with RMID 4 starts executing, there may be 1234 cache misses. Similarly, at time 612, which may correspond to the time task 2 completes execution before a context switch, there may be 2234 cache misses. Therefore, based on these metrics, the impact detector 112 may determine that task 2 resulted in 1000 cache misses. The cache misses and/or the scheduling information (e.g., that task 2 was executed, duration of execution slices, etc.) and/or cache occupancies may be used by the impact detector 112 and/or classifier 114 to classify buckets and/or tasks. Embodiments are not limited in these contexts.

A processor such as processor 104 may have an execution unit to execute program instructions. When an instruction requests to read from memory 106 and/or the caches 118, the execution unit may interface with a memory unit of the processor 104. The memory unit may attempt to identify the requested data in successive levels of the memory hierarchy, starting with the lowest level cache (e.g., an LI cache), the next level cache (e.g., an L2 cache), the last level cache (e.g., an L3 cache), and ending with memory 106. If the data is not in the caches 118 but is in the memory, the data is copied into one of the caches 118. When this copying occurs, it may overwrite and/or evict other data from the caches 118.

The resource manager 120 may tag the cache lines as being associated with their owners (through RMIDs). Furthermore, the resource manager may track of the current number of cache lines associated with that RMID. In some embodiments, the resource manager 120 may tag only a subset of the cache lines (e.g., 15%), as a representative of the whole cache activity.

Considering two example tasks, a first task and a second task, first task may be associated with a first bucket, associated in turn with the RMID tag 4. The 2nd second task may be associated with a second bucket, associated in turn with the RMID tag 5. Therefore, in such an example, the following Table 1A depicts an empty cache 118 with zero tagged cache lines.

TABLE 1A

| Cache Line | Data | Tag |
|---|---|---|
| #1 | | |
| #2 | | |
| #3 | | |
| #4 | | |
| #5 | | |
| #6 | | |

Similarly, the following table 2A depicts the per-RMID cache line allocation counters, which are empty at this stage.

TABLE 2A

| Tag | # of Lines |
|---|---|
| 1 | 0 |
| 2 | 0 |
| 3 | 0 |
| 4 | 0 |
| 5 | 0 |

As the first task executes, the impact detector 112 may instruct the resource manager 120 to tag the newly allocated cache lines with the RMID tag (tag 4) associated with the first task (task 1). During execution of the first task, there may be two cache misses in the cache 118, and a component of the system 102 (e.g., the resource manager 120, a cache allocator, memory management unit, etc.) may cache the data into cache lines 2 and 3. Table 1B depicts the cache after the caching of the data into lines 2 and 3.

TABLE 1B

| Cache Line | Data | Tag |
|---|---|---|
| #1 | | |
| #2 | Data of task 1 | 4 |
| #3 | Data of task 1 | 4 |
| #4 | | |
| #5 | | |
| #6 | | |

Similarly, table 2B depicts the per-RMID cache allocation counters after the caching of data into lines 2 and 3 and the resource manager 120 updates the associated cache line allocation counters:

TABLE 2B

| Tag | # of Lines |
|---|---|
| 1 | 0 |
| 2 | 0 |
| 3 | 0 |
| 4 | 2 |
| 5 | 0 |

As the second task executes, the impact detector 112 may instruct the resource manager 120 to tag the newly allocated cache lines with the RMID tag (tag 5) associated with the second task (task 2). During execution of the second task, there may be one miss in the cache 118, and a component of the system 102 (e.g., the resource manager 120, a cache allocator, memory management unit, etc.) may cache the data into cache line 4. Table 1C depicts the cache after the caching of the data into line 4.

TABLE 1C

| Cache Line | Data | Tag |
|---|---|---|
| #1 | | |
| #2 | Data of task 1 | 4 |
| #3 | Data of task 1 | 4 |
| #4 | Data of task 2 | 5 |
| #5 | | |
| #6 | | |

Similarly, table 2C depicts the per-RMID cache allocation counters after the caching of data into line 4.

TABLE 2C

| Tag | # of Lines |
|---|---|
| 1 | 0 |
| 2 | 0 |
| 3 | 0 |
| 4 | 2 |
| 5 | 1 |

The first task may resume execution. As such, the impact detector 112 may instruct the resource manager 120 to tag the newly allocated cache lines with the RMID tag (tag 4) associated with the first task (task 1). During execution of the first task, there may be two more cache misses in the cache 118, and a component of the system 102 (e.g., the resource manager 120, a cache allocator, memory management unit, etc.) may cache the data into cache lines 2 and 3. Doing so may overwrite the data previously associated with the first task in cache lines 2 and 3. Table 1D depicts the cache after the caching of the new data into lines 2 and 3.

TABLE 1D

| Cache Line | Data | Tag |
|---|---|---|
| #1 | | |
| #2 | New Data of task 1 | 4 |
| #3 | New Data of task 1 | 4 |
| #4 | Data of task 2 | 5 |
| #5 | | |
| #6 | | |

Similarly, table 2D depicts the per-RMID cache line allocation counters after the caching of new data into lines 2 and 3.

TABLE 2D

| Tag | # of Lines |
|---|---|
| 1 | 0 |
| 2 | 0 |
| 3 | 0 |
| 4 | 2 |
| 5 | 1 |

The second task may then resume execution. The impact detector 112 may instruct the resource manager 120 to tag the newly allocated cache lines with the RMID tag (tag 5) associated with the second task (task 2). During execution of the second task, there may be another miss in the cache 118, and a component of the system 102 (e.g., the resource manager 120, cache allocator, memory management unit, etc.) may cache the data into cache line 5. Table 1E depicts the cache after the caching of the data into cache line 5.

TABLE 1E

| Cache Line | Data | Tag |
|---|---|---|
| #1 | | |
| #2 | Data of task 1 | 4 |
| #3 | Data of task 1 | 4 |
| #4 | Data of task 2 | 5 |
| #5 | Data of task 2 | 5 |
| #6 | | |

Similarly, table 2E depicts the per-RMID cache line allocation counters after the caching of data into line 5.

TABLE 2E

| Tag | # of Lines |
|---|---|
| 1 | 0 |
| 2 | 0 |
| 3 | 0 |
| 4 | 2 |
| 5 | 2 |

The first task may resume execution. As such, the impact detector 112 may instruct the resource The first task may resume execution. As such, the impact detector 112 may instruct the resource manager 120 to tag the newly allocated cache lines with the RMID tag (tag 4) associated with the first task (task 1). During execution of the first task, there may be two more cache misses in the cache 118, and a component of the system 102 (e.g., the resource manager 120, a cache allocator, memory management unit, etc.) may cache the data into cache lines 2 and 3. Doing so may overwrite the data previously associated with the first task in cache lines 2 and 3. Table 1F depicts the cache after the caching of the new data into lines 2 and 3.

TABLE 1F

| Cache Line | Data | Tag |
|---|---|---|
| #1 | | |
| #2 | Newer Data of task 1 | 4 |
| #3 | Newer Data of task 1 | 4 |
| #4 | Data of task 2 | 5 |
| #5 | Data of task 2 | 5 |
| #6 | | |

Similarly, table 2F depicts the per-RMID cache line allocation counters after the caching of data into lines 2 and 3.

TABLE 2F

| Tag | # of Lines |
|---|---|
| 1 | 0 |
| 2 | 0 |
| 3 | 0 |
| 4 | 2 |
| 5 | 2 |

The second task may then resume execution. The impact detector 112 may instruct the resource manager 120 to tag the newly allocated cache lines with the RMID tag (tag 5) associated with the second task (task 2). During execution of the second task, there may be two misses in the cache 118, and a component of the system 102 (e.g., the resource manager 120, a cache allocator, memory management unit, etc.) may cache the data into cache lines 2 and 6, evicting task 1's data in line 2. Table 1G depicts the cache after the caching of the data into lines 2 and 6.

TABLE 1G

| Cache Line | Data | Tag |
|---|---|---|
| #1 | | |
| #2 | Data of task 2 | 5 |
| #3 | Newer Data of task 1 | 4 |
| #4 | Data of task 2 | 5 |
| #5 | Data of task 2 | 5 |
| #6 | Data of task 2 | 5 |

Table 2G depicts the updated per-RMID cache line allocation counters.

TABLE 2G

| Tag | # of Lines |
|---|---|
| 1 | 0 |
| 2 | 0 |
| 3 | 0 |
| 4 | 1 |
| 5 | 4 |

As shown, because the data associated with task 1 is evicted from line 2, the number of lines associated with task 1 is reduced from 2 to 1. Similarly, because task 2 has been allocated lines 2 and 6, the number of lines associated with task 2 is increased from 2 to 4. In summary, task 1 may have had six total cache misses, but now occupies one cache line. Similarly, task 2 may have had four total cache misses, but now occupies four cache lines. Because of the cache misses and the cache occupancies, the classifier 114 may classify task 2 as a noisy neighbor. However, the classifier 114 may not classify task 1 as a noisy neighbor, even though it had more cache misses than task 2.

The resource manager 120 allows the impact detector 112 to assess the evolution of these cache misses and cache occupancies in time (e.g., 1 cache line for task 1, 4 cache lines for the task 2). Furthermore, the impact detector 112 may determine the delta (difference) between cache allocations and evictions during monitoring, even though in some embodiments the impact detector 112 may not know which lines are allocated to a given task.

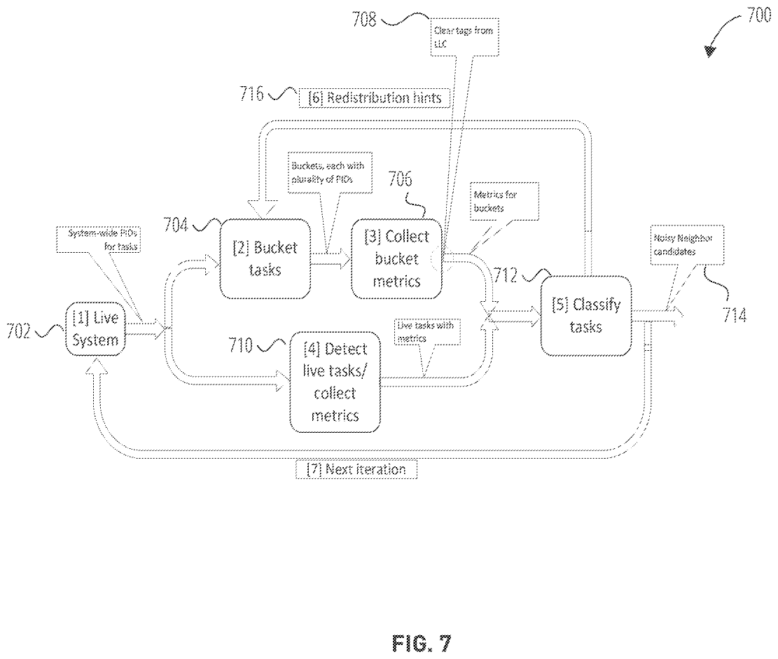

FIG. 7 is a flow diagram 700 showing an example embodiment of noisy neighbor detection. Although the flow diagram 700 is discussed with reference to software entities 204 (e.g., tasks 110a-110c), the flow diagram 700 may be applied to the I/O sources 206. Embodiments are not limited in these contexts.

The flow diagram 700 may include a resource monitoring reset mechanism to allow reuse of RMIDs. Generally, without the reset mechanism, the impact detector 112 may not easily reuse RMIDs. For example, in embodiments where the resource manager 120 aggregates the per-RMID bucket measurements, the measurements are associated with the consumers associated with the bucket, meaning that changing the contents of a bucket (e.g., by removing a task), would require remeasuring the bucket cache occupancies (starting from zero) by associating the bucket with a new RMID. For example, the impact detector 112 may not be able to distinguish between the cache occupancies and/or bandwidth utilization of individual tasks from the same bucket 202a sharing a common RMID. Therefore, in some embodiments, after changes in bucket contents, the new RMIDs may be associated with buckets after each iteration of the flow diagram 700 (and/or flow diagram 400 or flow diagram 500).

For example, at the start of a new iteration, there may be cache lines that are tagged with RMIDs from previous iterations. These RMIDs that tag the cache lines must be distinct from the RMIDs selected by the impact detector 112 in the current iteration such that all monitored buckets start an iteration with zero cache occupancies. As such, during an iteration, the bucket with a noisy neighbor may exhibit growth in cache occupancies. When this behavior is consistent over multiple iterations, the classifier 114 may classify the task as a noisy neighbor and/or noisy neighbor candidate. Otherwise, if the behavior is not consistent, the classifier 114 may classify the task as a bursty task, as the data may be reflective of a temporary burst in cache use.

As shown, at block 702, a plurality of software entities 204 such as tasks 110a-110c may be executed on one or more computing systems 102. At block 704, the impact detector 112 assigns one or more of the tasks to respective buckets of the plurality of buckets (e.g., buckets 202a-202d). Doing so causes each bucket 202a-202d to be associated with a respective subset of the plurality of tasks. At block 706, the impact detector 112 may receive metrics describing the execution of the tasks and/or I/O sources 206 in the buckets 202a-202d, e.g., cache misses, memory bandwidth, cache occupancies, etc. At block 708, the impact detector 112 may instruct the resource manager 120 to clear the RMID tags from the cache 118. The resource manager 120 may further clear the per-RMID metrics based on the instruction.

At block 710, which may occur in parallel with one or more of blocks 704, 706, or 708, the impact detector 112 detects live tasks as described herein. The impact detector 112 may further collect metrics for the tasks. At block 712, the classifier 114 may classify the tasks 110a-110c. Doing so may return one or more noisy neighbor candidates at block 714. As stated, in some embodiments, all tasks and/or I/O sources associated with a bucket that has been classified as a noisy neighbor (and/or a noisy neighbor candidate) may be individually monitored by the resource manager 120. In some embodiments, block 716 includes the classifier 114 providing redistribution hints to the impact detector 112 for bucket redistribution in subsequent iterations of flow diagram 700.

The following examples may describe one or more embodiments of the flow diagram 700. For example, the resource manager 120 may be limited to a predetermined number of RMID tags, such as 10 RMID tags. Therefore, during each iteration of the flow diagram 700, each bucket is associated with one of the RMID tags. Because associating fewer tasks with a bucket may require fewer operations to identify noisy neighbors, some embodiments may use all available RMID tags at once. The following Table 3 depicts an example of cache lines, data, and tags:

TABLE 3

| Cache Line | Data | Tag |
|---|---|---|
| #1 | | 1 |
| #2 | | 2 |
| #3 | | 1 |
| #4 | | 4 |
| #5 | | 1 |
| #6 | | 6 |
| #7 | | 1 |
| #8 | | 8 |
| #9 | | 1 |
| #10 | | 3 |
| #11 | | 5 |
| #12 | | 7 |
| #13 | | 9 |
| #14 | | 10 |
| #15 | | 1 |

Table 4 depicts tags and the per-RMID cache line allocation counters for each of the 10 RMIDs at the end of block 606 in the first iteration:

| Tag | # of Lines |
|---|---|
| 1 | 6 |
| 2 | 1 |
| 3 | 1 |
| 4 | 1 |
| 5 | 1 |
| 6 | 1 |
| 7 | 1 |
| 8 | 1 |
| 9 | 1 |
| 10 | 1 |

Based on these metrics, the bucket with RMID tag 1 (which may have 40% cache utilization) may include a noisy neighbor task. Another iteration of flow diagram 700 may then be performed to redistribute the tasks. However, because the resource manager 120 remembers the cache line tags and per-RMID allocation counters (the metrics) between iterations (as there may not be a mechanism to reset them), RMID tag 1 (and associated counters) cannot be reused because the bucket would start with a 40% cache utilization. After the second iteration of flow diagram 700, the tasks from the bucket associated with RMID tag 1 could still have high cache utilization and become noisy neighbor candidates, which is not desirable.

Therefore, the impact detector 112 may identify an unused RMID (e.g., an RMID that does not have cache occupancies or does have cache occupancies below a threshold). After one iteration, the cache 118 may be tagged according to Table 5:

TABLE 5

| Cache Line | Data | Tag |
|---|---|---|
| #1 | | 1 |
| #2 | | 2 |
| #3 | | 1 |
| #4 | | 4 |
| #5 | | 1 |
| #6 | | 6 |
| #7 | | 1 |
| #8 | | |
| #9 | | 1 |
| #10 | | 3 |
| #11 | | 5 |
| #12 | | 7 |
| #13 | | |
| #14 | | 1 |
| #15 | | 1 |

Similarly, Table 6 may depict the RMID tags and the number of cache lines the tag has been allocated to.

TABLE 6

| Tag | # of Lines |
|---|---|
| 1 | 6 |
| 2 | 1 |
| 3 | 1 |
| 4 | 1 |
| 5 | 1 |
| 6 | 1 |
| 7 | 1 |
| 8 | 0 |
| 9 | 0 |
| 10 | 0 |

Considering an example where four buckets are to be created and monitored by the impact detector 112, the impact detector 112 may select RMID tags 8, 9, or 10, as these tags are not applied to any cache lines, and therefore have no cache occupancies. Similarly, the impact detector 112 may select RMID tags 2, 3, 4, 5, 6, or 7, as these tags are associated with low cache occupancies (e.g., because each tag is associated with one cache line, which may be lower than a predetermined threshold). However, resetting the RMID tags and the per-RMID counters in block 708 may remove these restrictions, allowing the use of all the RMID tags during the next iteration, all starting from 0 occupancies.

After any iteration, the impact detector 112 may need to be able to find, by querying the resource manager 120, at least 1 RMID with zero or close-to-zero occupancy to be able to associate at least 1 new bucket with that RMID. One way for the impact detector 112 to ensure RMID availability is to reduce the number of buckets—thus RMIDs—used during an iteration.

For example, if the pool of RMIDs offered by the resource manager 120 has a pool of 400 RMIDs then the impact detector 112 may choose to use only the first 40 RMIDs in the first iteration. In the 2nd iteration, the impact detector 112 may use the next 40 RMIDs from the remaining 360 RMIDs not used during the first iteration, and so on. In some embodiments, the impact detector 112 uses a smaller chunk than the full pool of RMIDs offered by the resource manager 120. In some embodiments, the RMIDs are not selected in sequential order. Reducing the number of buckets may increase the number of iterations needed to isolate noisy neighbors by increasing the number of collisions.

For example, considering a first bucket associated with a first task identified as task 1 and a second task identified as task 2, where the first bucket is associated with an example RMID tag 4. Similarly, a second bucket may be associated with a third task identified as task 3 and a fourth task identified as task 4, where the second bucket is associated with an example RMID tag 5. In the example, the first task may be a noisy neighbor to be detected.

Table 7A depicts an example of the cache 118 after a first iteration of flow diagram 700.

TABLE 7A

| Cache Line | Data | Tag |
|---|---|---|
| #1 | Data of noisy task 1 | 4 |
| #2 | Data of noisy task 1 | 4 |
| #3 | Data of noisy task 1 | 4 |
| #4 | Data of noisy task 1 | 4 |
| #5 | Data of noisy task 1 | 4 |
| #6 | Data of noisy task 1 | 4 |
| #7 | Data of task 2 | 4 |
| #8 | Data of task 3 | 5 |
| #9 | Data of task 4 | 5 |
| #10 | | |
| #11 | | |
| #12 | | |
| #13 | | |
| #14 | | |
| #15 | | |

As shown in Table 7A, tag 4 is applied to 7 cache lines. If the corresponding buckets have high cache occupancies (e.g., above a threshold), they are noisy buckets and the associated first and second tasks become noisy neighbor candidates. Similarly, tag 4 is applied to 2 cache lines, while the third and fourth tasks do not exhibit noisy neighbor behavior. However, there may be no way to separate the cache lines of task 1 and task 2 to obtain their respective cache occupancies because their allocated cache lines are marked with the same tag 4.

Therefore, in the next iteration, tasks 1 and 2 may be redistributed to different buckets having distinct RMIDs. However, because tasks 1 and 2 cannot be removed from the bucket with tag 4, two new bucket associations may be created. The first new bucket association may include associating RMID tag 6 with tasks 1 and 3 and the second new bucket association may include associating RMID tag 7 with tasks 2 and 4. Table 7B depicts the contents of the cache 118 after the creation and monitoring of the new bucket associations.

TABLE 7B

| Cache Line | Data | Tag |
|---|---|---|
| #1 | Data of noisy task 1 | 6 |
| #2 | Data of noisy task 1 | 6 |
| #3 | Data of noisy task 1 | 6 |
| #4 | Data of noisy task 1 | 6 |
| #5 | Data of noisy task 1 | 6 |
| #6 | Data of noisy task 1 | 6 |
| #7 | Data of task 3 | 6 |
| #8 | Data of task 2 | 7 |
| #9 | Data of task 4 | 7 |
| #10 | | |
| #11 | | |
| #12 | | |
| #13 | | |
| #14 | | |
| #15 | | |

Therefore, after the second iteration, tasks 1, 2, 3, and 4 may be active tasks. However, task 1 may be in a noisy bucket twice (e.g., after the first and second iterations), while tasks 2, 3, and 4 may be in a noisy bucket once (e.g., after one of the first or second iterations). Therefore, the first task may be a noisy neighbor candidate.

By resetting the metrics of the resource manager 120, however, all RMID tags can be used during each iteration. By using more RMID tags, more buckets can be used to identify noisy neighbors, which may cause the noisy neighbors to be identified faster than when not using all RMID tags. For example, having more buckets, means being able to distribute fewer resource consumers per bucket. For example, having more buckets means fewer collisions among the resource users from that bucket, and having fewer resource users in a bucket means a noisy bucket would have fewer associated noisy neighbor candidates. Embodiments are not limited in these contexts.

As stated, embodiments disclosed herein are not limited to monitoring any particular type of shared resource. Furthermore, in some embodiments, different types of monitoring can be applied to a shared resource. For example, occupancy of caches 118 and/or memories 106 may be monitored. Similarly, the queue lengths, occupancy, and/or bandwidth between any two resources may be monitored (e.g., the bandwidth between the last level cache 118 and memory 106, bandwidth to the devices 116, bandwidth of an interconnect of the processor 104, etc.). Therefore, embodiments disclosed herein may detect noisy neighbors to any tag-based monitoring mechanism where the tags (e.g., RMID tags) are limited in number compared to the number of consumers sharing the resource, the shared resource supports aggregated monitoring of use by consumers associated with a given tag, or there is an orthogonal way to identify active consumers (e.g., based on number of requests per second, etc.). Consumers may include the software entities 204 and/or the I/O sources 206.

Therefore, noisy neighbor detection may be extended to I/O devices such as the devices 116. However, in some embodiments, the noisy neighbors for the devices 116 may be detected on a coarser granularity (e.g., at the function level or the link level). For example, for PCIe devices, the granularity may be at a function-level. Similarly, for CXL devices, the granularity may be at the link level. From the point of view of the impact detector 112, the PID of a software entity may be equivalent to the address of an I/O source 206.

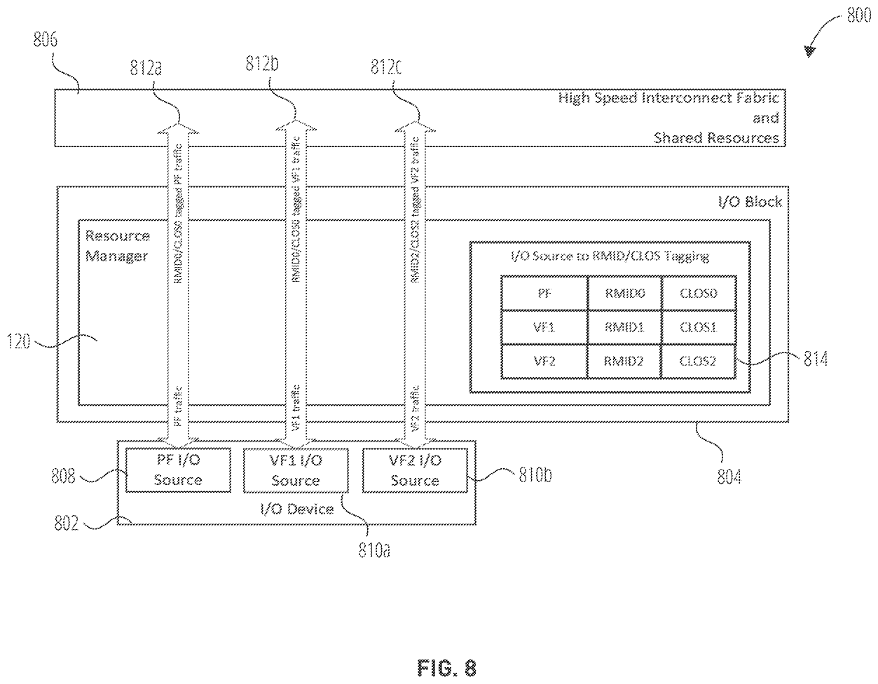

FIG. 8 is a schematic 800 depicting an example of detecting I/O sources 206 of peripheral devices as noisy neighbors. The device 802 is representative of the device 116 and/or the I/O sources 206. In the example depicted in FIG. 8, the device 802 is coupled to a fabric 806 (which may be a component of the system 102) via an I/O block 804. The I/O block 804 may be a PCIe bridge or PCIe endpoint. The device 802 may be an SIOV device providing at least one physical function 808 and a plurality of virtual functions (VFs) 810a-810b. The physical functions 808 and the VFs 810a-810b are representative of I/O Sources 206. The virtual functions 810a-810b may expose the physical function 808 to different software entities 204 (e.g., tasks 110a-110c, virtual machines, containers, etc.). In some embodiments, the physical function 808 and each virtual function 810a-b may be considered distinct I/O sources 206 of the same I/O device 802. In such examples, the PF I/O Source 808 of I/O device 802 may send traffic 812a. Similarly, VF1 I/O Source 810a of device 802 may send traffic 812b, and I/O source 810b of device 802 may send traffic 812c.

Generally, to identify an I/O source 206 (e.g., a device 802 and/or a component thereof) as a noisy neighbor, the resource manager 120 may define mappings 814 to associate the I/O sources 206 to an RMID and/or a CLOS. When traffic going through the I/O block 804 is identified from a given I/O source 206, the resource manager 120 may tag the traffic with the RMID and/or CLOS of traffic associated with the I/O source 206 in the mappings 814, before the traffic reaches the fabric 806. When traffic goes through the I/O block 804, the resource manager 120 matches the source of the traffic with the I/O source 206 from the association in the mappings 814. If a match is found, the resource manager 120 tags the I/O traffic with the corresponding RMID/CLOS from the mappings 814.

For example, if traffic comes from physical function 808, the resource manager 120 may tag the traffic with RMID0/CLOS0 based on the mappings 814. Similarly, if traffic comes from virtual function 810a, the resource manager 120 may tag the traffic with RMID1/CLOS1 based on the mappings 814 (where virtual function 810a is associated with “VF1” in the mappings 814). As another example, if traffic comes from virtual function 810b, the resource manager 120 may tag the with RMID2/CLOS2 based on the mappings 814 (where virtual function 810b is associated with “VF2” in the mappings 814).

By RMID-tagging upstream traffic (e.g., traffic from the device 802 to the memory 106 and/or caches 118), the resource manager 120 provides visibility for monitoring the cache 118 occupancies and/or memory 106 bandwidth. For monitoring the cache 118, I/O traffic tagged with one RMID, when it reaches the target cache level, may impact measured cache occupancy associated with that RMID and in turn with the bucket associated with that RMID. Similarly, for memory bandwidth monitoring, I/O traffic tagged with one RMID may reach the main memory, which may determine, in turn, changes in memory bandwidth utilization associated with that RMID and in turn with the bucket associated with that RMID. In some embodiments, the occupancy and bandwidth of CLOS-tagged upstream traffic can be controlled through mechanisms such as cache capacity allocation control and memory bandwidth control. Doing so allows the impact detector 112 to receive the per-RMID metric data for the buckets, and to allow the classifier 114 to identify the I/O sources 206 as noisy neighbors.

An I/O source 206 may exhibit noisy behavior through high cache occupancy and memory bandwidth traffic. By associating the I/O sources 206 with a bucket 202a-202d, then associating that bucket 202a-202d with an RMID, having the resource manager 120 tag the I/O source 206 traffic with that RMID, then reading back the resource utilization associated with that RMID, which in turn corresponds to the resource utilization of that bucket, a noisy I/O source 206 can be identified through the noisy behavior of its bucket 202a-202d.

Therefore, for upstream traffic, considering the set of physical functions 808 and virtual functions 810a-810b of the device 802 as a distinct I/O sources 206, the classifier 114 may detect individual noisy I/O functions (physical or virtual) just like for any other “generic” I/O source 206. In the example depicted in FIG. 8, the device 802 may be a NIC with one physical function 808, and two virtual functions 810a-810b, for a total of three functions (and thus three I/O sources 206). To detect a noisy neighbor, the impact detector 112 may map each I/O source 206 to a bucket (for a total of three buckets). For example, physical function 808 may be mapped to bucket 202a, virtual function 810a may be mapped to bucket 202b, and virtual function 810b may be mapped to bucket 202c. The impact detector 112 may then associate each bucket with a respective RMIDs (for a total of three mappings between buckets and RMIDs). Over time, the resource manager 120 may monitor the resource utilization of the three RMIDs (which correspond to the resource utilization of the mapped buckets). The classifier 114 may identify, based on the resource utilization, one or more buckets with noisy neighbors. Generally, buckets with high resource use may be more likely to contain noisy neighbors. Noisy functions (e.g., physical functions 808 and virtual functions 810a-810b) are identified by tracing the mapping of RMIDs of the buckets with high resource utilization metrics and the mappings 814. The impact detector 112 may instruct the resource manager 120 to monitor and tag I/O traffic of the I/O sources 206 with the RMIDs of the buckets associated with the I/O sources 206.

To identify noisy downstream traffic (e.g., traffic from the processor 104 to the physical functions 808 and/or virtual functions 810a-810b), the classifier 114 may identify the noisy neighbor among the software entities 204 that are associated with the physical functions 808 and virtual functions 810a-810b as described herein (e.g., via flow diagram 400, flow diagram 500, flow diagram 700, logic flow 1000, etc.). These software entities 204 may include a guest VM, a virtual processor, and/or a thread of a VM in charge of the VF, a hypervisor, and/or an operating system 108 accessing the physical function 808.

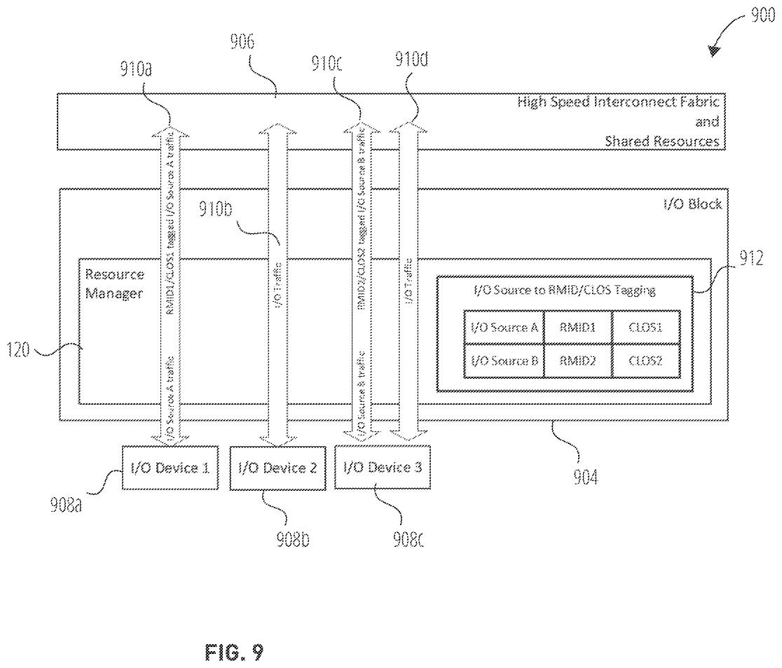

FIG. 9 is a schematic 900 depicting an embodiment of detecting I/O sources 206 as noisy neighbors. As shown, one or more I/O devices may include I/O devices 908a-908c. The I/O devices 908a-908c are representative of the devices 116 and the I/O sources 206, e.g., PCIe devices (e.g., NICs, storage devices), CXL devices (e.g., CXL accelerators, CXL memory pools, etc.), integrated accelerator devices (e.g., data streaming accelerator, compression accelerators, encryption accelerators, in memory analytics accelerators, mathematics accelerators, AI accelerators, etc.), load balancers, and the like. I/O devices 908a-908c may have more than one I/O source 206. For example, a PCIe device may have the device itself, their channels 222, physical functions 220, and virtual functions 220 as I/O sources 206. Similarly, CXL devices may have the device itself, and their links 218 as I/O sources 206. Similarly, virtual communication channels 222 (e.g., PCIe virtual channels) may be I/O sources 206.

In the example depicted in FIG. 9, the I/O devices 908a-908c are coupled to a fabric 906 (which may be a component of the system 102) via an I/O block 904. The I/O block 904 may be a PCIe bridge or PCIe endpoint. An instance of the resource manager 120 may be included in the I/O block 904. In some embodiments, each I/O device 908a-908c may be associated with one or more I/O sources sending I/O traffic 910a-910d. For example, an I/O Source A of I/O device 908a may send traffic 910a, I/O device 908b may send traffic 910b, I/O Source B of I/O device 908c may send traffic 910c, and I/O device 908c may send traffic 910d.

A data store of mappings 912 may associate an I/O source (and correspondingly, the associated I/O device 908a-908c) to an RMID and/or a class of service (CLOS). By associating the I/O sources with RMIDs, the mappings 912 may associate the I/O sources with one or more buckets 202. In the example depicted in FIG. 9, based on the mappings 912, the resource manager 120 may be configured to match traffic coming from “I/O Source A” of “I/O device 908a” and apply RMID1/CLOS1 tags to that traffic. Similarly, the resource manager 120 may be configured to match traffic coming from “I/O Source B” of “I/O device 908c” and apply RMID2/CLOS2 tags to that traffic.

If “I/O Source A” in the mappings 912, which may be I/O device 908a, acts as a noisy neighbor and fills the LLC with I/O traffic tagged with RMID1, then the LLC occupancy associated with RMID1 may be impactful. Thus, the bucket associated with RMID1 may exhibit noisy behavior and all the entities from this bucket are more likely to be noisy neighbors, including but not limited to “I/O Source A” (which may be associated with I/O device 908a).

Similarly, if the LLC occupancy associated with RMID2 (which may be associated with I/O device 908c) is low, then the entities from the bucket associated with RMID2 are less likely to be noisy neighbors, including but not limited to “I/O Source B” (which may be associated with I/O device 908c). Embodiments are not limited in these contexts.

To identify noisy neighbors (e.g., traffic 910a-910d and/or associated I/O devices 908a-908c), the classifier 114 may identify noisy neighbors as described elsewhere herein (e.g., via flow diagram 400, flow diagram 500, flow diagram 700, logic flow 1000, etc.). Embodiments are not limited in these contexts.

In some embodiments, noisy neighbor detection may be implemented across multiple resource domains. For example, an instance of the detection algorithm may be performed within a single resource domain and/or on multiple resource domains. In some embodiments, several instances may be run in parallel on distinct resource domains. The resource manager 120 features disclosed herein apply to the whole system (or a subset thereof) or to a resource domain (or a subset thereof). The resource manager 120 belonging to a resource domain may only report resource utilization for the shared resources in that resource domain. When evaluating the degree of noisiness of a software entity, in some embodiments, only the occupancy of the shared resources belonging to the resource domain where that entity is executed is considered by the impact detector 112 and/or classifier 114.

In some embodiments, software entities can be flexibly executed on CPU agents belonging to any resource domain. Their degree of noisiness is therefore associated with a resource domain. For example, software entities that are active in a resource domain (e.g., executed on a CPU agent belonging to that resource domain) have higher chances of being noisy neighbors in that resource domain. As another example, software entities that are not active in a resource domain (e.g., not executed on a CPU agent belonging to that resource domain) have lower chances of being noisy neighbors in that resource domain. When a software entity is migrated/pinned to be executed on a different resource domain, it may have less chances of being a noisy neighbor candidate in its previous resource domain and more chances of being a noisy neighbor candidate in its current resource domain. Similarly, software entities active in more resource domains can be noisy neighbor candidates in all of them. In some embodiments, I/O sources 206 may only access the LLC from the resource domain they belong to. Therefore, agents can be noisy neighbor candidates only over the shared resources they have access to.

In some embodiments, the processor 104 may expose two or more virtual cores through simultaneous multithreading (SMT). One example is Intel Hyper-Threading technology. In some embodiments, the granularity of resource monitoring by the resource manager 120 can be: (i) at the processor 104 (physical core) level: the resource manager 120 allows setting an RMID per physical core, or (ii) at the virtual core level: the resource manager 120 allows setting an RMID per virtual core. When SMT is available and enabled, the resource manager 120 may monitor at the physical core level, and the resource manager 120 cannot distinguish between resource utilizations of software entities executed on distinct virtual cores belonging to the same physical core. In such embodiments, since all the virtual cores of a physical processor share a common RMID, software entities running on them must be associated with a common bucket. In some embodiments, the impact detector 112 and/or resource manager 120 may: (i) constrain the execution of the software entities (e.g., through pinning) such that all the software entities running on the same physical core belong to the same bucket during an iteration, (ii) pin the software entities to run on different processors 104 (physical cores), to place them in different buckets for noisy neighbor isolation, and/or (iii) disable SMT or disallow execution on more than one virtual core of processor 104.

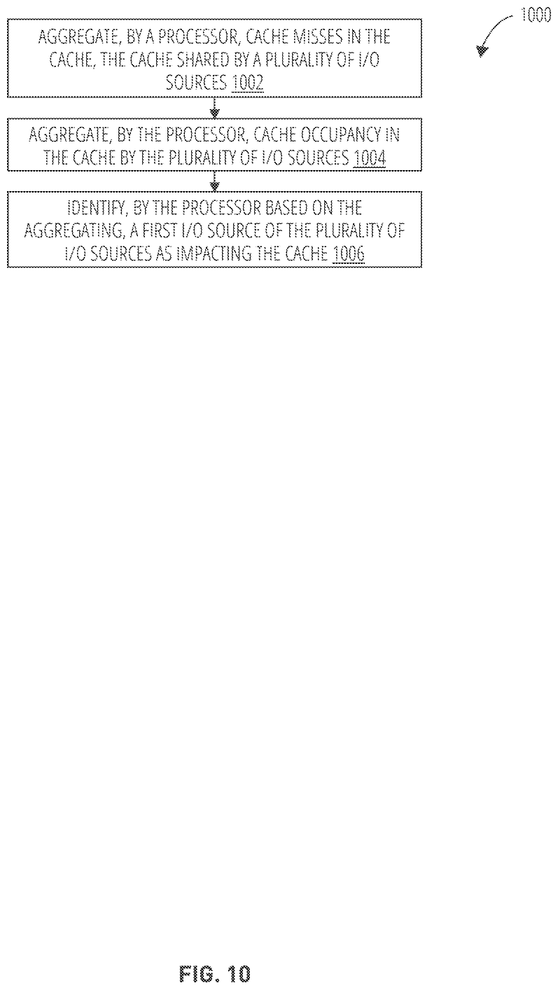

FIG. 10 illustrates an embodiment of a logic flow 1000. The logic flow 1000 may be representative of some or all of the operations executed by one or more embodiments described herein. For example, the logic flow 1000 may include some or all of the operations for noisy neighbor detection. Embodiments are not limited in this context.

In block 1002, logic flow 1000 aggregates, by a processor such as processor 104, cache misses in a cache such as cache 118, the cache shared by a plurality of I/O sources such as I/O sources 206. The cache may further be shared by tasks 110a-110c. In block 1004, logic flow 1000 aggregates, by the processor, cache occupancy in the cache by the plurality of I/O sources 206. In block 1006, logic flow 1000 identifies, by the processor based on the aggregating, a first I/O source 206 of the plurality of I/O sources 206 as impacting the cache. Embodiments are not limited in these contexts.

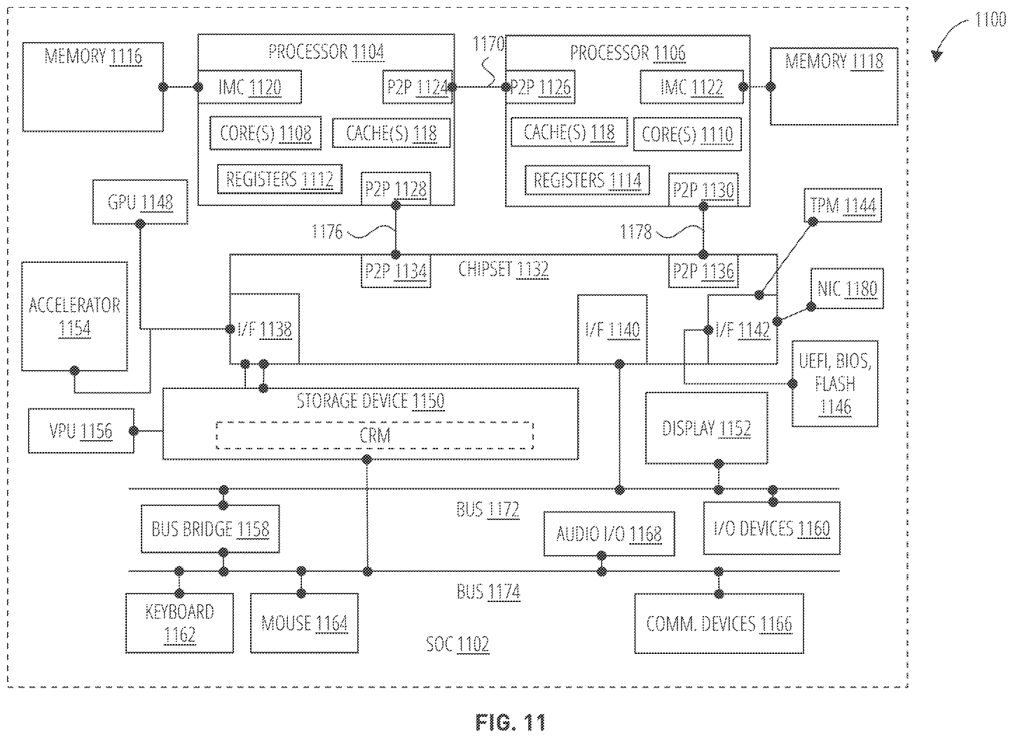

FIG. 11 illustrates an embodiment of a system 1100. System 1100 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), an Infrastructure Processing Unit (IPU), a data processing unit (DPU), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. Examples of IPUs include the AMD® Pensando IPU. Examples of DPUs include the Fungible DPU, the Marvell® OCTEON and ARMADA DPUs, the NVIDIA BlueField® DPU, the ARM® Neoverse N2 DPU, and the AMD® Pensando DPU. In other embodiments, the system 1100 may have a single processor with one core or more than one processor. Note that the term “processor” refers to a processor with a single core or a processor package with multiple processor cores. In at least one embodiment, the computing system 1100 is representative of the components of the system 102, device 802, and/or I/O devices 908a-908c. More generally, the computing system 1100 is configured to implement all logic, systems, logic flows, methods, apparatuses, and functionality described herein with reference to previous figures.

As used in this application, the terms “system” and “component” and “module” are intended to refer to a computer-related entity, either hardware, a combination of hardware and software, software, or software in execution, examples of which are provided by the exemplary system 1100. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

As shown in FIG. 11, system 1100 comprises a system-on-chip (SoC) 1102 for mounting platform components. System-on-chip (SoC) 1102 is a point-to-point (P2P) interconnect platform that includes a first processor 1104 and a second processor 1106 coupled via a point-to-point interconnect 1170 such as an Ultra Path Interconnect (UPI). In other embodiments, the system 1100 may be of another bus architecture, such as a multi-drop bus. Furthermore, each of processor 1104 and processor 1106 may be processor packages with multiple processor cores including core(s) 1108 and core(s) 1110, respectively. While the system 1100 is an example of a two-socket (2S) platform, other embodiments may include more than two sockets or one socket. For example, some embodiments may include a four-socket (4S) platform or an eight-socket (8S) platform. Each socket is a mount for a processor and may have a socket identifier. Note that the term platform may refers to a motherboard with certain components mounted such as the processor 1104 and chipset 1132. Some platforms may include additional components and some platforms may only include sockets to mount the processors and/or the chipset. Furthermore, some platforms may not have sockets (e.g., SoC, or the like). Although depicted as a SoC 1102, one or more of the components of the SoC 1102 may also be included in a single die package, a multi-chip module (MCM), a multi-die package, a chiplet, a bridge, and/or an interposer. Therefore, embodiments are not limited to a SoC.

The processor 1104 and processor 1106 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures may also be employed as the processor 1104 and/or processor 1106. Additionally, the processor 1104 need not be identical to processor 1106.

Processor 1104 includes an integrated memory controller (IMC) 1120, point-to-point (P2P) interface 1124 and P2P interface 1128. Similarly, the processor 1106 includes an IMC 1122, P2P interface 1126 and P2P interface 1130. IMC 1120 and IMC 1122 couple the processor 1104 and processor 1106, respectively, to respective memories (e.g., memory 1116 and memory 1118). Memory 1116 and memory 1118 may be portions of the main memory (e.g., a dynamic random-access memory (DRAM)) for the platform such as double data rate type 4 (DDR4) or type 5 (DDR5) synchronous DRAM (SDRAM). In the present embodiment, the memory 1116 and the memory 1118 locally attach to the respective processors (e.g., processor 1104 and processor 1106). In other embodiments, the main memory may couple with the processors via a bus and shared memory hub. The memories 1116, 1118 are representative of the memory 106. Processor 1104 includes registers 1112 and processor 1106 includes registers 1114.

System 1100 includes chipset 1132 coupled to processor 1104 and processor 1106. Furthermore, chipset 1132 can be coupled to storage device 1150, for example, via an interface (I/F) 1138. The I/F 1138 may be, for example, a Peripheral Component Interconnect Express (PCIc) interface, a Compute Express Link® (CXL) interface, a Universal Chiplet Interconnect Express (UCIe) interface, a die-to-die interface, the TSMC® system on integrated chip (SoIC) (TSMC-SOIC®), or the Open High Bandwidth Interface (OpenHBI). Storage device 1150 can store instructions executable by circuitry of system 1100 (e.g., processor 1104, processor 1106, GPU 1148, accelerator 1154, vision processing unit 1156, or the like). For example, storage device 1150 can store instructions for the impact detector 112, the classifier 114, or the like.

Processor 1104 couples to the chipset 1132 via P2P interface 1128 and P2P 1134 while processor 1106 couples to the chipset 1132 via P2P interface 1130 and P2P 1136. Direct media interface (DMI) 1176 and DMI 1178 may couple the P2P interface 1128 and the P2P 1134 and the P2P interface 1130 and P2P 1136, respectively. DMI 1176 and DMI 1178 may be a high-speed interconnect that facilitates, e.g., eight Giga Transfers per second (GT/s) such as DMI 3.0. In other embodiments, the processor 1104 and processor 1106 may interconnect via a bus.

The chipset 1132 may comprise a controller hub such as a platform controller hub (PCH). The chipset 1132 may include a system clock to perform clocking functions and include interfaces for an I/O bus such as a universal serial bus (USB), peripheral component interconnects (PCIs), CXL interconnects, UCIe interconnects, interface serial peripheral interconnects (SPIs), integrated interconnects (12Cs), TSMC-SOIC, a die-to-die interface, OpenHBI, and the like, to facilitate connection of peripheral devices on the platform. In other embodiments, the chipset 1132 may comprise more than one controller hub such as a chipset with a memory controller hub, a graphics controller hub, and an input/output (I/O) controller hub.

In the depicted example, chipset 1132 couples with a trusted platform module (TPM) 1144 and UEFI, BIOS, FLASH circuitry 1146 via I/F 1142. The TPM 1144 is a dedicated microcontroller designed to secure hardware by integrating cryptographic keys into devices. The UEFI, BIOS, FLASH circuitry 1146 may provide pre-boot code.

Furthermore, chipset 1132 includes the I/F 1138 to couple chipset 1132 with a high-performance graphics engine, such as, graphics processing circuitry or a graphics processing unit (GPU) 1148. In some embodiments, the GPU 1148 is a general purpose GPU (GPGPU). In other embodiments, the system 1100 may include a flexible display interface (FDI) (not shown) between the processor 1104 and/or the processor 1106 and the chipset 1132. The FDI interconnects a graphics processor core in one or more of processor 1104 and/or processor 1106 with the chipset 1132.

The system 1100 is operable to communicate with wired and wireless devices or entities via the network interface controller (NIC) 180 using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, 3G, 4G, LTE, 5G, 6G wireless technologies, among others. Thus, the communication can be a predefined structure as with a conventional network or simply an ad hoc communication between at least two devices. Wi-Fi networks use radio technologies called IEEE 802.11x (a, b, g, n, ac, ax, etc.) to provide secure, reliable, fast wireless connectivity. A Wi-Fi network can be used to connect computers to each other, to the Internet, and to wired networks (which use IEEE 802.3-related media and functions).

Additionally, accelerator 1154 and/or vision processing unit 1156 can be coupled to chipset 1132 via I/F 1138. The accelerator 1154 is representative of any type of accelerator device (e.g., a data streaming accelerator, cryptographic accelerator, cryptographic coprocessor, neural network accelerator, matrix math accelerator, GPGPU, an offload engine, etc.). Examples of an accelerator 1154 include the AMD Instinct® or Radeon® accelerators, the NVIDIA® HGX and SCX accelerators, and the ARM Ethos-U NPU. The accelerator 1154 is representative of the accelerators 902.

The accelerator 1154 may be a device including circuitry to accelerate copy operations, data encryption, hash value computation, data comparison operations (including comparison of data in memory 1116 and/or memory 1118), and/or data compression. For example, the accelerator 1154 may be a USB device, PCI device, PCIe device, CXL device, UCIe device, and/or an SPI device. The accelerator 1154 can also include circuitry arranged to execute machine learning (ML) related operations (e.g., training, inference, etc.) for ML models. Generally, the accelerator 1154 may be specially designed to perform computationally intensive operations, such as hash value computations, comparison operations, cryptographic operations, and/or compression operations, in a manner that is more efficient than when performed by the processor 1104 or processor 1106. Because the load of the system 1100 may include hash value computations, comparison operations, cryptographic operations, and/or compression operations, the accelerator 1154 can greatly increase performance of the system 1100 for these operations.

The accelerator 1154 may be embodied as any type of device, such as a coprocessor, application-specific integrated circuit (ASIC), field-programmable gate array (FPGA), functional block, IP core, graphics processing unit (GPU), a processor with specific instruction sets for accelerating one or more operations, or other hardware accelerator capable of performing the functions described herein. In some embodiments, the accelerator 1154 may be packaged in a discrete package, an add-in card, a chipset, a multi-chip module (e.g., a chiplet, a dielet, etc.), and/or an SoC. Embodiments are not limited in these contexts.

The accelerator 1154 may include one or more dedicated work queues and one or more shared work queues (each not pictured). Generally, a shared work queue is configured to store descriptors submitted by multiple software entities. The software may be any type of executable code, such as a process, a task, a thread, an application, a virtual machine, a container, a microservice, etc., that share the accelerator 1154. For example, the accelerator 1154 may be shared according to the Single Root I/O virtualization (SR-IOV) architecture and/or the Scalable I/O virtualization (SIOV) architecture. Embodiments are not limited in these contexts. In some embodiments, software uses an instruction to atomically submit the descriptor to the accelerator 1154 via a non-posted write (e.g., a deferred memory write (DMWr)). One example of an instruction that atomically submits a work descriptor to the shared work queue of the accelerator 1154 is the ENQCMD command or instruction (which may be referred to as “ENQCMD” herein) supported by the Intel® Instruction Set Architecture (ISA). However, any instruction having a descriptor that includes indications of the operation to be performed, a source virtual address for the descriptor, a destination virtual address for a device-specific register of the shared work queue, virtual addresses of parameters, a virtual address of a completion record, and an identifier of an address space of the submitting process is representative of an instruction that atomically submits a work descriptor to the shared work queue of the accelerator 1154. The dedicated work queue may accept job submissions via commands such as the movdir64b instruction.

Various I/O devices 1160 and display 1152 couple to the bus 1172, along with a bus bridge 1158 which couples the bus 1172 to a second bus 1174 and an I/F 1140 that connects the bus 1172 with the chipset 1132. In one embodiment, the second bus 1174 may be a low pin count (LPC) bus. Various devices may couple to the second bus 1174 including, for example, a keyboard 1162, a mouse 1164 and communication devices 1166.

Furthermore, an audio I/O 1168 may couple to second bus 1174. Many of the I/O devices 1160 and communication devices 1166 may reside on the system-on-chip (SoC) 1102 while the keyboard 1162 and the mouse 1164 may be add-on peripherals. In other embodiments, some or all the I/O devices 1160 and communication devices 1166 are add-on peripherals and do not reside on the system-on-chip (SoC) 1102.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method. The required structure for a variety of these machines will appear from the description given.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

The various elements of the devices as previously described with reference to the Figures may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

The following examples pertain to further embodiments, from which numerous permutations and configurations will be apparent.

Example 1 includes a method of monitoring impact on a cache, the method comprising: aggregating, by a processor, cache misses in the cache, the cache shared by a plurality of input/output (I/O) sources; aggregating, by the processor, cache occupancies in the cache by the plurality of I/O sources; and identifying, by the processor based on the aggregating, a first I/O source of the plurality of I/O sources as impacting the cache.

Example 2 includes the subject matter of example 1, further comprising: classifying, by the processor, the plurality of I/O sources based on the cache misses and the cache occupancies.

Example 3 includes the subject matter of example 1 or 2, wherein the first I/O source is associated with another device, the method further comprising: identifying, by the processor, the another device as impacting the cache.

Example 4 includes the subject matter of example 3, wherein the another device comprises a Peripheral Component Interconnect Express (PCIe) device, a Universal Chiplet Interconnect Express (UCIe) interface, a die-to-die interface, a TSMC system on integrated chip (SoIC) (TSMC-SOIC), an Open High Bandwidth Interface (OpenHBI), or a Compute Express Link (CXL) device.

Example 5 includes the subject matter of any one of examples 1 to 4, further comprising prior to the aggregating the cache misses: associating, by the processor, respective subsets of the plurality of I/O sources with a respective bucket of a plurality of buckets.

Example 6 includes the subject matter of example 5, further comprising subsequent to identifying the first I/O source as impacting the cache: reassociating, by the processor, the subsets of the plurality of I/O sources with the plurality of buckets based on the cache misses and the cache occupancies of the plurality of I/O sources.

Example 7 includes the subject matter of any one of examples 1 to 6, wherein the determination that the first I/O source impacts the cache is based on an amount of the cache used by the first I/O source and an amount of the cache allocated to a task or another I/O source.

Example 8 includes the subject matter of any one of examples 1 to 7, further comprising: performing, by the processor, a mitigation action based on one or more of: (i) a redistribution operation, (ii) changing operating frequency of one or more devices, (iii) modifying one or more resource allocations, (iv) terminating one or more tasks, (v) suspending the one or more tasks, (vi) a pinning operation, (vii) an isolation operation, (vii) adjusting packet pacing, (ix) factors of a service level agreement (SLA), or (x) factors of a service level objective (SLO).

Example 9 includes a non-transitory computer-readable storage medium, the computer-readable storage medium including instructions executable by a processor to cause the processor to: aggregate cache telemetry data associated with a cache, the cache shared by a plurality of input/output (I/O) sources, the cache telemetry data comprising cache miss data and cache occupancy data; determine cache telemetry associated with the plurality of I/O sources; and identify, based on the determination, a first I/O source of the plurality of I/O sources as impacting the cache.

Example 10 includes the subject matter of example 9, wherein the instructions further cause the processor to: classify the plurality of I/O sources based on the cache telemetry data.

Example 11 includes the subject matter of example 9 or 10, wherein the first I/O source is associated with another device, wherein the instructions further cause the processor to: identify the another device as impacting the cache.

Example 12 includes the subject matter of example 11, wherein the another device comprises a Peripheral Component Interconnect Express (PCIe) device, a Universal Chiplet Interconnect Express (UCIe) interface, a die-to-die interface, a TSMC system on integrated chip (SoIC) (TSMC-SOIC), an Open High Bandwidth Interface (OpenHBI), or a Compute Express Link (CXL) device.

Example 13 includes the subject matter of any one of examples 9 to 12, wherein the instructions further cause the processor to, prior to the aggregating the cache telemetry data: associate respective subsets of the plurality of I/O sources with a respective bucket of a plurality of buckets.

Example 14 includes the subject matter of example 13, wherein the instructions further cause the processor to, subsequent to identifying the first I/O source as impacting the cache: reassociate the subsets of the plurality of I/O sources with the plurality of buckets based on the cache telemetry associated with the plurality of I/O sources.

Example 15 includes the subject matter of any one of examples 9 to 14, wherein the determination that the first I/O source impacts the cache is based on an amount of the cache used by the first I/O source and an amount of the cache allocated to a task or another I/O source.

Example 16 includes the subject matter of any one of examples 9 to 15, wherein the instructions further cause the processor to: perform a mitigation action based on one or more of: (i) a redistribution operation, (ii) changing operating frequency of one or more devices, (iii) modifying one or more resource allocations, (iv) terminating one or more tasks, (v) suspending the one or more tasks, (vi) a pinning operation, (vii) an isolation operation, (vii) adjusting packet pacing, (ix) factors of a service level agreement (SLA), or (x) factors of a service level objective (SLO).

Example 17 includes a computing apparatus comprising: a processor comprising a cache; and a memory storing instructions executable by the processor to cause the processor to: aggregate cache misses in the cache, the cache shared by a plurality of input/output (I/O) sources; aggregate cache occupancies in the cache by the plurality of I/O sources; and identify, based on the aggregating, a first I/O source of the plurality of I/O sources as impacting the cache.

Example 18 includes the subject matter of example 17, wherein the instructions further cause the processor to: classify the plurality of I/O sources based on the cache misses and the cache occupancies.

Example 19 includes the subject matter of examples 17 or 18, wherein the first I/O source is associated with another device, wherein the instructions further cause the processor to: identify the another device as impacting the cache.

Example 20 includes the subject matter of example 19, wherein the another device comprises a Peripheral Component Interconnect Express (PCIe) device, a Universal Chiplet Interconnect Express (UCIe) interface, a die-to-die interface, a TSMC system on integrated chip (SoIC) (TSMC-SOIC), an Open High Bandwidth Interface (OpenHBI), or a Compute Express Link (CXL) device.

Example 21 includes the subject matter of any one of examples 17 to 20, wherein the instructions further cause the processor to, prior to the aggregating the cache misses: associate respective subsets of the plurality of I/O sources with a respective bucket of a plurality of buckets.

Example 22 includes the subject matter of example 21, wherein the instructions further cause the processor to, subsequent to identifying the first I/O source as impacting the cache: reassociate the subsets of the plurality of I/O sources with the plurality of buckets based on the cache misses and the cache occupancies of the plurality of I/O sources.

Example 23 includes the subject matter of any one of examples 17 to 22, wherein the determination that the first I/O source impacts the cache is based on an amount of the cache used by the first I/O source and an amount of the cache allocated to a task or another I/O source.

Example 24 includes the subject matter of example 17, wherein the instructions further cause the processor to: perform a mitigation action based on one or more of: (i) a redistribution operation, (ii) changing operating frequency of one or more devices, (iii) modifying one or more resource allocations, (iv) terminating one or more tasks, (v) suspending the one or more tasks, (vi) a pinning operation, (vii) an isolation operation, (vii) adjusting packet pacing, (ix) factors of a service level agreement (SLA), or (x) factors of a service level objective (SLO).

Example 25 includes an apparatus, comprising: means for aggregating cache misses in a cache, the cache shared by a plurality of input/output (I/O) sources; means for aggregating cache occupancies in the cache by the plurality of I/O sources; and means for identifying, based on the aggregating, a first I/O source of the plurality of I/O sources as impacting the cache.

Example 26 includes the subject matter of example 25, further comprising: means for classifying the plurality of I/O sources based on the cache misses and the cache occupancies.

Example 27 includes the subject matter of example 25 or 26, wherein the first I/O source is associated with another device, the apparatus further comprising: means for identifying the another device as impacting the cache.

Example 28 includes the subject matter of example 27, wherein the another device comprises a Peripheral Component Interconnect Express (PCIe) device, a Universal Chiplet Interconnect Express (UCIe) interface, a die-to-die interface, a TSMC system on integrated chip (SoIC) (TSMC-SOIC), an Open High Bandwidth Interface (OpenHBI), or a Compute Express Link (CXL) device.

Example 29 includes the subject matter of any one of examples 25 to 28, further comprising prior to the aggregating the cache misses: means for associating respective subsets of the plurality of I/O sources with a respective bucket of a plurality of buckets.

Example 30 includes the subject matter of example 29, further comprising subsequent to identifying the first I/O source as impacting the cache: means for reassociating the subsets of the plurality of I/O sources with the plurality of buckets based on the cache misses and the cache occupancies of the plurality of I/O sources.

Example 31 includes the subject matter of any one of examples 25 to 30, wherein the determination that the first I/O source impacts the cache is based on an amount of the cache used by the first I/O source and an amount of the cache allocated to a task or another I/O source.

Example 32 includes the subject matter of any one of examples 25 to 31, further comprising: means for performing a mitigation action based on one or more of: (i) a redistribution operation, (ii) changing operating frequency of one or more devices, (iii) modifying one or more resource allocations, (iv) terminating one or more tasks, (v) suspending the one or more tasks, (vi) a pinning operation, (vii) an isolation operation, (vii) adjusting packet pacing, (ix) factors of a service level agreement (SLA), or (x) factors of a service level objective (SLO).

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

What is claimed is:

1. A method of monitoring impact on a cache, the method comprising:
aggregating, by a processor, cache misses in the cache, the cache shared by a plurality of input/output (I/O) sources;
aggregating, by the processor, cache occupancies in the cache by the plurality of I/O sources; and
identifying, by the processor based on the aggregating, a first I/O source of the plurality of I/O sources as impacting the cache.

2. The method of claim 1, further comprising:
classifying, by the processor, the plurality of I/O sources based on the cache misses and the cache occupancies.

3. The method of claim 1, wherein the first I/O source is associated with another device, the method further comprising:
identifying, by the processor, the another device as impacting the cache.

4. The method of claim 3, wherein the another device comprises a Peripheral Component Interconnect Express (PCIe) device, a Universal Chiplet Interconnect Express (UCIe) interface, a die-to-die interface, a TSMC system on integrated chip (SoIC) (TSMC-SOIC), an Open High Bandwidth Interface (OpenHBI), or a Compute Express Link (CXL) device.

5. The method of claim 1, further comprising prior to the aggregating the cache misses:
associating, by the processor, respective subsets of the plurality of I/O sources with a respective bucket of a plurality of buckets.

6. The method of claim 5, further comprising subsequent to identifying the first I/O source as impacting the cache:
reassociating, by the processor, the subsets of the plurality of I/O sources with the plurality of buckets based on the cache misses and the cache occupancies of the plurality of I/O sources.

7. The method of claim 1, wherein the determination that the first I/O source impacts the cache is based on an amount of the cache used by the first I/O source and an amount of the cache allocated to a task or another I/O source.

8. The method of claim 1, further comprising:
performing, by the processor, a mitigation action based on one or more of: (i) a redistribution operation, (ii) changing operating frequency of one or more devices, (iii) modifying one or more resource allocations, (iv) terminating one or more tasks, (v) suspending the one or more tasks, (vi) a pinning operation, (vii) an isolation operation, (vii) adjusting packet pacing, (ix) factors of a service level agreement (SLA), or (x) factors of a service level objective (SLO).

9. A non-transitory computer-readable storage medium, the computer-readable storage medium including instructions executable by a processor to cause the processor to:
aggregate cache telemetry data associated with a cache, the cache shared by a plurality of input/output (I/O) sources, the cache telemetry data comprising cache miss data and cache occupancy data;
determine cache telemetry associated with the plurality of I/O sources; and
identify, based on the determination, a first I/O source of the plurality of I/O sources as impacting the cache.

10. The computer-readable storage medium of claim 9, wherein the instructions further cause the processor to:
classify the plurality of I/O sources based on the cache telemetry data.

11. The computer-readable storage medium of claim 9, wherein the first I/O source is associated with another device, wherein the instructions further cause the processor to:
identify the another device as impacting the cache.

12. The computer-readable storage medium of claim 11, wherein the another device comprises a Peripheral Component Interconnect Express (PCIe) device, a Universal Chiplet Interconnect Express (UCIe) interface, a die-to-die interface, a TSMC system on integrated chip (SoIC) (TSMC-SOIC), an Open High Bandwidth Interface (OpenHBI), or a Compute Express Link (CXL) device.

13. The computer-readable storage medium of claim 9, wherein the instructions further cause the processor to, prior to the aggregating the cache telemetry data:
associate respective subsets of the plurality of I/O sources with a respective bucket of a plurality of buckets.

14. The computer-readable storage medium of claim 13, wherein the instructions further cause the processor to, subsequent to identifying the first I/O source as impacting the cache:
reassociate the subsets of the plurality of I/O sources with the plurality of buckets based on the cache telemetry associated with the plurality of I/O sources.

15. The computer-readable storage medium of claim 9, wherein the determination that the first I/O source impacts the cache is based on an amount of the cache used by the first I/O source and an amount of the cache allocated to a task or another I/O source.

16. A computing apparatus comprising:
a processor comprising a cache; and
a memory storing instructions executable by the processor to cause the processor to:
aggregate cache misses in the cache, the cache shared by a plurality of input/output (I/O) sources;
aggregate cache occupancies in the cache by the plurality of I/O sources; and
identify, based on the aggregating, a first I/O source of the plurality of I/O sources as impacting the cache.

17. The computing apparatus of claim 16, wherein the first I/O source is associated with another device, wherein the instructions further cause the processor to:
identify the another device as impacting the cache.

18. The computing apparatus of claim 17, wherein the another device comprises a Peripheral Component Interconnect Express (PCIe) device, a Universal Chiplet Interconnect Express (UCIe) interface, a die-to-die interface, a TSMC system on integrated chip (SoIC) (TSMC-SOIC), an Open High Bandwidth Interface (OpenHBI), or a Compute Express Link (CXL) device.

19. The computing apparatus of claim 16, wherein the instructions further cause the processor to, prior to the aggregating the cache misses:
associate respective subsets of the plurality of I/O sources with a respective bucket of a plurality of buckets.

20. The computing apparatus of claim 16, wherein the determination that the first VO source impacts the cache is based on an amount of the cache used by the first I/O source and an amount of the cache allocated to a task or another I/O source.
